(19) United States
(12) Patent Application Publication
(10) Pub. No.: US 2014/0208274 A1
(43) Pub. Date: Jul. 24, 2014

(54) CONTROLLING A COMPUTING-BASED DEVICE USING HAND GESTURES

(71) Applicant: MICROSOFT CORPORATION, Redmond, WA (US)

(72) Inventors: Samuel Gavin Smyth, Cambridge (GB); Peter John Ansell, Cambridge (GB); Christopher Jozef O'Prey, Bury St Edmunds Suffolk (GB); Mitchel Alan Goldberg, Cambridge (GB); Jamie Daniel Joseph Shotton, Cambridge (GB); Toby Sharp, Cambridge (GB); Shahram Izadi, Cambridge (GB); Abigail Jane Sellen, Cambridge (GB); Richard Malcolm Banks, Egham (GB); Kenton O'Hara, Bristol (GB); Richard Harry Robert Harper, Cambridge (GB); Eric John Greveson, Edinburgh (GB); David Alexander Butler, Cambridge (GB); Stephen E Hodges, Cambridge (GB)

(73) Assignee: MICROSOFT CORPORATION, Redmond, WA (US)

(21) Appl. No.: 13/744,823

(22) Filed: Jan. 18, 2013

(51) Int. Cl. G06F 3/01

(52) U.S. Cl. CPC G06F 3/017
USPC 715/863

(57) ABSTRACT

Methods and system for controlling a computing-based device using both input received from a traditional input device (e.g. keyboard) and hand gestures made on or near a reference object (e.g. keyboard). In some examples, the hand gestures may comprise one or more hand touch gestures and/or one or more hand air gestures.

### BACKGROUND

There has been significant research over the past decades on Natural User Interfaces (NUI). NUI includes new gesture-based interfaces that use touch or touch-less interactions or the full body to enable rich interactions with a computing device. Whilst pushing the boundaries of human computer interaction, these systems have not meant the end of traditional desktop computing using keyboard and mouse.

Specifically, the desktop computer is still preferred for many day-to-day computing tasks, in particular those requiring extensive authoring, editing or fine manipulation, such as document writing, coding, creating presentations or graphic design tasks.

However, while many desktop activities are well-tuned to mouse and keyboard, there are elements of these tasks such as mode switches, window and task management, menu selection and certain types of navigation which are offloaded to shortcut and modifier keys or context menus.

The embodiments described below are not limited to implementations which solve any or all of the disadvantages of known systems for controlling computing devices.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Described herein are methods and systems for controlling a computing-based device using both input received from a traditional input device (e.g. keyboard) and hand gestures made on or near a reference object (e.g. keyboard). In some examples, the hand gestures may comprise one or more touch hand gestures and/or one or more free-air hand gestures.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a control system for controlling a computing-based device;

FIG. 2 is a schematic diagram of an example capture device of FIG. 1;

FIG. 3 is a block diagram of a process for detecting hand gestures made on and/or near a keyboard;

FIG. 4 is a flow diagram of an example method for detecting the background of an image;

FIG. 5 is a flow diagram of an example method for identifying objects in an image;

FIG. 6 is a flow diagram of an example method for determining the location of a user's forefinger;

FIG. 7 is a flow diagram of an example method for determining the plane of the desktop;

FIG. 8 is a chart of an example touch hand gesture set;

FIG. 9 is a schematic diagram of an example scroll and pan gesture;

FIG. 10 is a schematic diagram of an example zoom gesture;

FIG. 11 is a schematic diagram of an example rotate gesture;

FIG. 12 is a schematic diagram of an example show application bar gesture;

FIG. 13 is a schematic diagram of an example show Charms bar gesture;

FIG. 14 is a schematic diagram of an example switch application gesture;

FIG. 15 is a schematic diagram of an example show recent applications gesture;

FIG. 16 is a chart of an example free-air hand gesture set;

FIG. 17 is a schematic diagram of an example close application gesture;

FIG. 18 is a schematic diagram of an example maximize window gesture;

FIG. 19 is a schematic diagram of an example shrink window gesture;

FIG. 20 is a schematic diagram of an example dock window gesture;

FIG. 21 is a schematic diagram of an example split screen gesture;

FIG. 22 is a schematic diagram of an example peek gesture;

FIG. 23 is a schematic diagram of an example peek and pin gesture;

FIG. 24 is a schematic diagram of an example peek and switch gesture;

FIG. 25 is a schematic diagram of an example search gesture;

FIG. 26 is a flow diagram of an example method for controlling a computing device; and

FIG. 27 is a block diagram of an exemplary computing-based device in which embodiments of the control system and/or methods may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

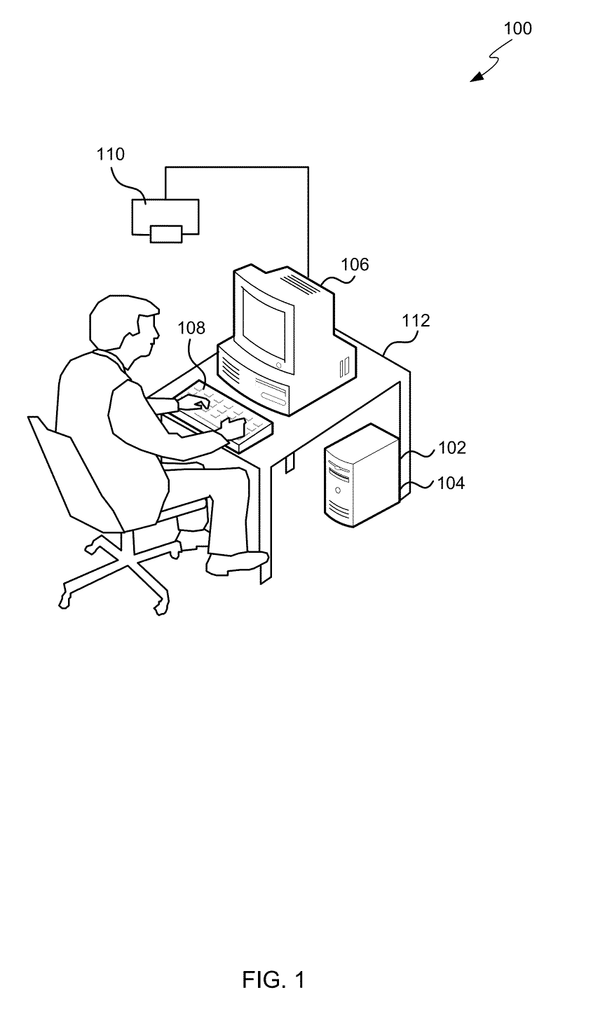

Reference is first made to FIG. 1, which illustrates an example control system 100 for controlling a computing-based device 102. In this example, the system 100 allows the computing-based device 102 to be controlled by traditional input devices (e.g. mouse and keyboard) and hand gestures. The supported hand gestures may be touch hand gestures, free-air gestures or a combination thereof. A “touch hand gesture” is any predefined movement of a hand or hands while in contact with a surface. The surface may or may not include touch sensors. A “free-air gesture” is any predefined movement of a hand or hands in the air where the hand or hands is/are not in contact with a surface.

By integrating both modes of control a user experiences the benefits of each of the control modes in an easy-to use manner. Specifically, many computing-based device 102 activities are tuned to traditional inputs (e.g. mouse and keyboard), in particular those requiring extensive authoring, editing or fine manipulation, such as document writing, coding, creating presentations or graphic design tasks. However, there are elements of these tasks, such as mode switches, windows and task management, menu selection and certain types of navigation which are offloaded to shortcut and modifier keys or context menus which can be more easily implemented using other control means, such as touch hand gestures and/or free-air hand gestures.

The computing-based device 102 shown in FIG. 1 is a traditional desktop computer with a separate processor component 104 and display screen 106; however, the methods and systems described herein may equally be applied to computing-based devices 102 wherein the processor component 104 and display screen 106 are integrated such as in a laptop computer or a tablet computer.

The control system 100 further comprises an input device 108, such as a keyboard, in communication with the computing-based device 102 that allows a user to control the computing-based device 102 through traditional means; a capture device 110 for detecting the location and movement of a user's hands with respect to a reference object in the environment (e.g. the input device 108); and software (not shown) to interpret the information obtained from the capture device 110 to control the computing-based device 102. In some examples, at least part of the software for interpreting the information from the capture device 110 is integrated into the capture device 110. In other examples, the software is integrated or loaded on the computing-based device 102. Although the control system 100 of FIG. 1 comprises a single capture device 110, the methods and principles described herein may be equally applied to control systems with multiple capture devices 110.

In FIG. 1, the capture device 110 is mounted above and pointing downward at the user's desktop or working surface 112. However, in other examples, the capture device 110 may be mounted in or on the reference object (e.g. keyboard); or another suitable object in the environment.

In operation, the user's hands can be tracked using the capture device 110 with respect to the reference object (e.g. keyboard) such that the position and movements of the user's hands can be interpreted by the computing-based device 102 (and/or the capture device 110) as touch hand gestures and/or free-air hand gestures that can be used to control the application being executed by the computing-based device 102. As a result, in addition to being able to control the computing-based device 102 via traditional inputs (e.g. keyboard and mouse) the user can control the computing-based device 102 by moving his or her hands in a predefined manner or pattern on, near or above the reference object (e.g. keyboard).

Accordingly, the control system 100 of FIG. 1 is capable of recognizing touch on and around a reference object (e.g. a keyboard) as well as free-air gestures above the reference object.

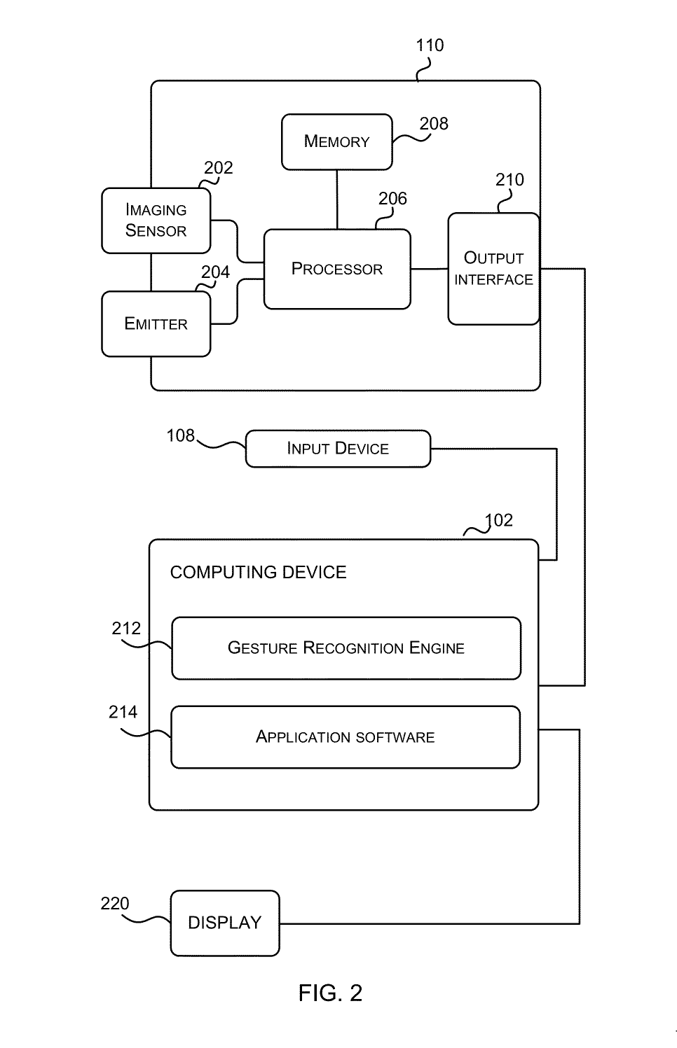

Reference is now made to FIG. 2, which illustrates a schematic diagram of a capture device 110 that may be used in the control system 100 of FIG. 1. The capture device 110 comprises at least one imaging sensor 202 for capturing images of the user's hands. The imaging sensor 202 may be a depth camera arranged to capture depth information of a scene. The depth information may be in the form of a depth image that includes depth values, i.e. a value associated with each image element (e.g. pixel) of the depth image that is related to the distance between the depth camera and an item or object located at that image element.

The depth information can be obtained using any suitable technique including, for example, time-of-flight, structured light, stereo image, or the like.

The captured depth image may include a two dimensional (2-D) area of the captured scene where each image element in the 2-D area represents a depth value such as length or distance of an object in the captured scene from the imaging sensor 202.

In some cases, the imaging sensor 202 may be in the form of two or more physically separated cameras that view the scene from different angles, such that visual stereo data is obtained that can be resolved to generate depth information.

The capture device 110 may also comprise an emitter 204 arranged to illuminate the scene in such a manner that depth information can be ascertained by the imaging sensor 202.

The capture device 110 may also comprise at least one processor 206, which is in communication with the imaging sensor 202 (e.g. depth camera) and the emitter 204 (if present). The processor 206 may be a general purpose microprocessor or a specialized signal/image processor. The processor 206 is arranged to execute instructions to control the imaging sensor 202 and emitter 204 (if present) to capture depth images. The processor 206 may optionally be arranged to perform processing on these images and signals, as outlined in more detail below.

The capture device 110 may also include memory 208 arranged to store the instructions for execution by the processor 206, images or frames captured by the imaging sensor 202, or any suitable information, images or the like. In some examples, the memory 208 can include random access memory (RAM), read only memory (ROM), cache, Flash memory, a hard disk, or any other suitable storage component. The memory 208 can be a separate component in communication with the processor 206 or integrated into the processor 206.

The capture device 110 may also include an output interface 210 in communication with the processor 206. The output interface 210 is arranged to provide data to the computing-based device 102 via a communication link. The communication link can be, for example, a wired connection (e.g. USB™, Firewire™, Ethernet™ or similar) and/or a wireless connection (e.g. WiFi™, Bluetooth™ or similar). In other examples, the output interface 210 can interface with one or more communication networks (e.g. the Internet) and provide data to the computing-based device 102 via these networks.

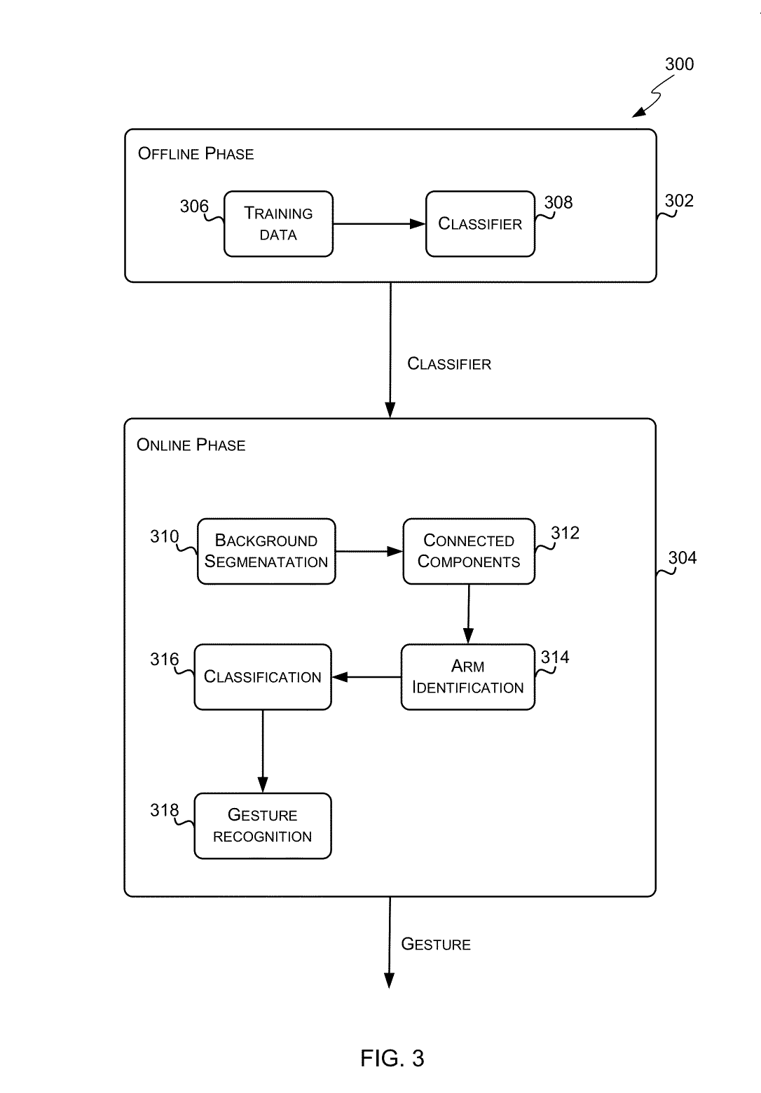

The computing-based device 102 may comprise a gesture recognition engine 212 that is configured to execute one or more functions related to gesture recognition. Example functions that may be executed by the gesture recognition engine 212 are described in reference to FIG. 3. For example, the gesture recognition engine 212 may be configured to classify each image element (e.g. pixel) of the image captured by the capture device 110 as either a salient hand part (e.g. fingertips, wrist and forearm and implicitly the palm) and/or as a hand state (e.g. palm up, palm down, first up or pointing or combinations thereof). The hand states are then used by the gesture recognition engine 212 as the basis for semantic gesture recognition. This approach to classification leads to a greatly simplified gesture recognition engine 212. For example, it allows gestures to be recognized by looking for a particular hand state for a predetermined number of images, or transitions between hand states.

Application software 214 may also be executed on the computing-based device 102 and controlled using the input received from the input device 108 (e.g. keyboard) and the output of the gesture recognition engine 212 (e.g. the detected touch and free-air hand gestures).

Reference is now made to FIG. 3 which is a block diagram of a process 300 for detecting gestures (touch hand gestures and free-air hand gestures) made on or near a reference object, such as a keyboard. The process comprises an offline phase 302 which is completed prior to runtime and an online phase 304 which is completed during runtime. Any or all of the online phase 304 may be executed or implemented by the gesture recognition engine 212 of FIG. 2. Details of a random decision forest classifier created in the offline phase 302 and used in the online phase 304 are given in co-pending U.S. patent application “Part and state detection for gesture recognition” O'Prey et al. filed on the same day as this application.

The offline phase 302 comprises two stages: a training data phase 306 and a classifier generation phase 308.

In the training data stage 306, synthetic training data is generated. In some examples, this may comprise posing a virtual 3D (three dimensional) model of a hand in the different discrete states and with slight variations in terms of joint-angle configurations and appearance (e.g. bone lengths and circumferences) to accommodate different users and styles of gesturing. In some examples, the states to be monitored comprise fingers-together facing up, inward or down; fingers spread facing up or down; fingers clenched facing up or down; thumbs and forefinger touching with palm inward; and forefinger pointing with palm face up, down or inward. However, it will be evident to a person of skill in the art that more, fewer and/or different states may be used.

2D (two dimensional) renderings of the 3D model are generated from many different viewpoints. In some examples, one set of rendering may equate to the synthetic depth map and another set may be generated with the 3D model textured with labeled data. The labels may identify a hand part (e.g. wrist, palm, thumb tip, forefinger tip and other finger tip) and/or a hand state. In some examples, some body parts (e.g. fingers, forearm and the palm) are shown in different colors. The color of the palm may also vary based on the state of the hand. This results in a series of depth maps with labeled hand parts and states. In other examples, other forms of rendering, such as rendering synthetic RGB or infrared images, may be used to generate maps with labeled hand parts and states.

While the use of synthetic images is useful for precisely annotated images, ensuring that the synthetic images closely match actual images of real hands is difficult. Accordingly, in some examples, in addition to using synthetic images, real hand images may be used to enhance the accuracy of the system. In some cases this is accomplished by observing real hands with both (a) a device that can accurately provide annotation of hand states; and (b) a target device. Examples of devices which may be used to accurately and automatically annotate positional information of a hand include track pads which produce accurate information about where hand contact points are and Microsoft™ Research's Digits, a wrist worn device that accurately tracks finger articulations. By recoding the output of the annotation device with a target device provides enhanced training data. In other cases this is accomplished by obtaining images of the real hand(s) and manually annotating the images.

The synthetic and/or real images generated in the training data stage 306 are then used in the classifier generation stage 308 to train a classifier, such as a Random Decision Forest (RDF) classifier. The classifier is used at runtime for hand state and hand part classification. Training the classifier may be computationally expensive, but is typically only performed once.

The decision forest generated by the training data is an ensemble of T decision tress, each comprising split and leaf nodes L. Each leaf node of tree t comprises a learned probability distribution Pₜ(c|u) for an image element (e.g. pixel) u over hand parts and hand states c. During classification simple binary decisions are repeatedly evaluated for each image component (e.g. pixel) in the image while descending through the tree structure.

The online phase 304 uses the classifier generated in the classifier generation stage 308 to generate hand state proposals and body part (e.g. fingertip, palm and forearm) detection. The hand state and body part proposals are then used to determine if one of the predetermined gestures have been executed by the user. The example online phase 304 of FIG. 3 comprises five stages: a background segmentation stage 310, a connected components stage 312, a hand identification stage 314, a classification stage 316, and a gesture recognition stage 318, however, in other examples, the online phase 304 may comprise more or fewer stages.

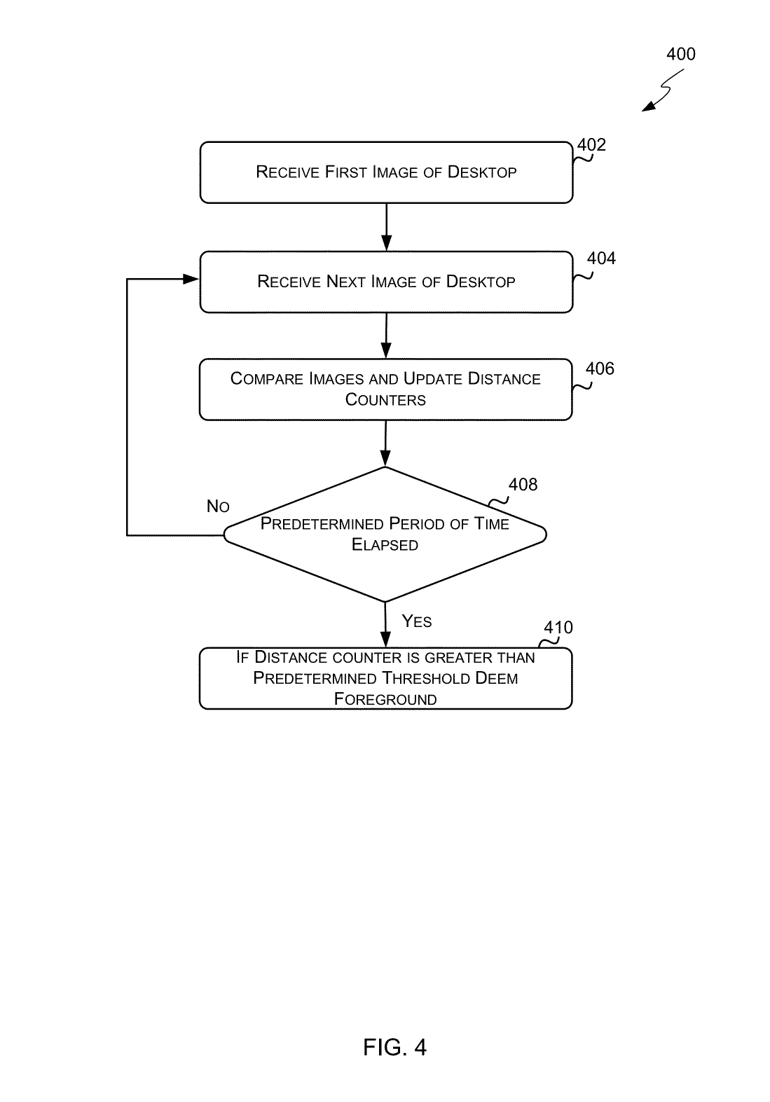

In the background segmentation stage 310, the image received from the capture device is analyzed to determine the background of the image. In some examples, the background is determined by generating an image of the entire desk excluding the user's hands and arms. However, these examples require the user to manually ensure their whole desk is visible to the camera and that their hands and arms are not in view. In other examples, the background is automatically determined on a periodic basis by building a per-image element (e.g. pixel) histogram for incoming frames over a predetermined period (e.g. 30 seconds) An example method 400 for detecting the background in this manner is described in reference to FIG. 4.

Once the background has been detected, the foreground objects of an image are extracted by subtracting the background from the image. It is then these foreground objects that are provided to the connected component stage.

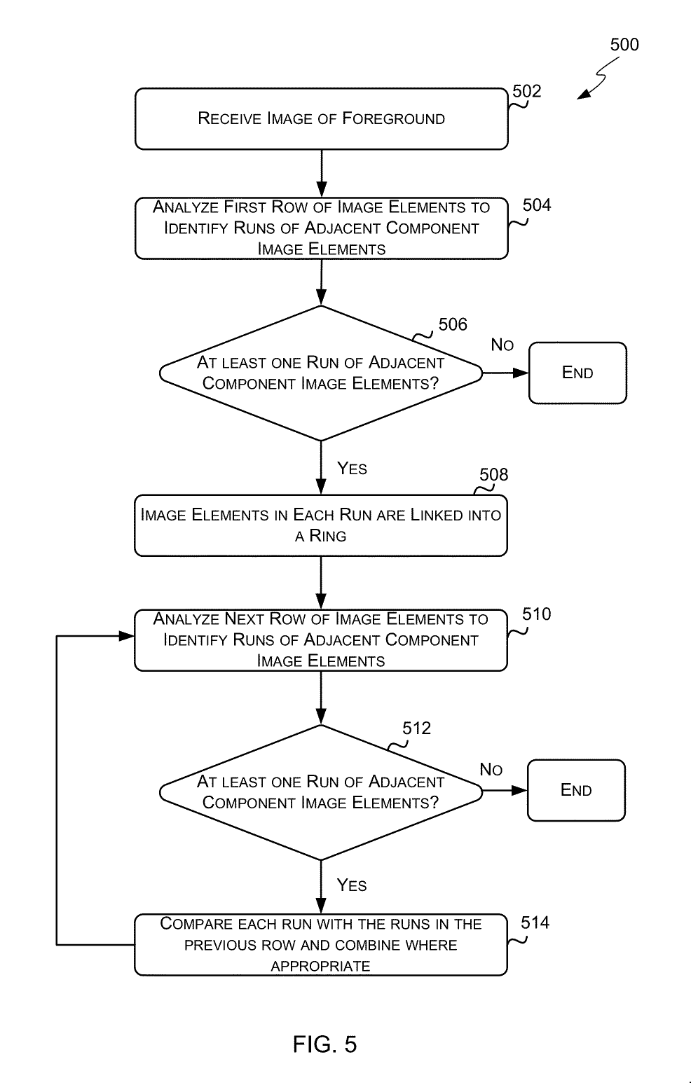

In the connected component stage 312, a connected component analysis is performed on the foreground objects to suppress salt and pepper noise and avoid smaller moving objects such as a moving mouse being classified. As is known to those of skill in that art, connected component analysis is an algorithmic application of graph theory used to connect regions in a digital image. One of the problems with traditional connected component techniques is that many cameras, such as depth cameras, produce a lot of noise, especially at the sharp edges between depths. This noise often results in collections of numerous small objects being identified. To help address this issue, in some examples, the traditional connected component technique may be improved by using the fact that any relevant component (e.g. arms) will start at the edge of the image. An example method 500 for implementing an improved connected component analysis is described in reference to FIG. 5. In other examples, this issue may be addressed by pre-processing the image with a smoothing operation, e.g. median filtering or bilateral filtering.

The arm identification stage 314 identifies the components from the connected component stage that are most likely to be the user's arms or arm. In some cases, the two largest components that enter the image from the edge towards the user and are within a predetermined minimum threshold size and a predetermined maximum threshold size are selected to be the arms. The minimum threshold size is the minimum number of image elements a component may have for the component to be considered a possible arm and the maximum threshold size the maximum number of image elements a component may have to be considered a possible arm. The predetermined threshold sizes may be dependent on the capture device 110 characteristics (e.g. the image size generated) and positioning (e.g. if the capture device 110 is closer to the desktop surface the components will be larger).

In some examples, the threshold sized is determined by placing real hands in view of the camera and counting the number of image elements in the hand. The minimum threshold may be determined by placing the hand at the edge of reasonable visibility at the furthest distance from the camera and down-scaling the number of image elements to accommodate child-sized hands. The maximum threshold may be determined by placing as much hand and arm in view of the camera as possible as close to the camera as reasonable and up-scaling the number of image elements to accommodate persons with larger than average arms and hands. In one example, for an image size of 320×240 pixels, the minimum threshold size may be 10,000 image elements.

In some examples, if there are two components that meet the criteria then the component which has the leftmost image element (e.g. pixel) on the image edge towards the user may be deemed to be the left arm and the other component may be deemed to be the right arm. If one component meets the predetermined criteria then the component may be deemed the left arm or the right arm depending on which side of the image the component enters from. For example, if the component enters the image on the left-hand side then the component may be deemed to be the left arm. Similarly, if the component enters the image on the right-hand side then the component may be deemed to be the right arm.

In other examples, if there are two components that meet the criteria then a classifier trained to disambiguate left and right arms (or hands) may be used to distinguish the left and right arms.

In the classification stage 316, the classifier generated in the classifier generation stage 308 is applied to at least a portion of the image elements (e.g. pixels) of the arm component(s) identified in the arm identification stage 314 to detect the state and/or parts of the arm.

As described above each leaf node of the decision tree t comprises a learned probability distribution Pₜ(c|u) for an image element (e.g. pixel) u over hand parts and hand states c. These distributions may then be averaged across the trees to arrive at the final distribution as shown in equation (1).

$$P ( c \vert u ) = \frac{1}{T} {\sum }_{t = 1}^{T} {P}_{t} ( c \vert u ) \qquad ( 1 )$$

P(c|u) is interpreted as a per-image element vote of which hand part the image element belongs to and which hand state it encodes.

In some examples, the per-pixel probabilities P(c|u) are summed together and a histogram generated. The hand state or part that has a probability that exceeds a predetermined threshold (e.g. 50%) is selected as the hand state and/or part. The thresholds used in the classification stage are based on the quality of the classifier and may vary for each hand pose. In some cases, the better the classifier, the higher the thresholds. The thresholds may be selected by obtaining an image of a particular hand pose, applying the classifier to the image, and selecting a value less than the probability (the sum of the per-pixel probabilities P(c|u)) that the hand is in the particular pose. In some examples, the thresholds may be between 20% and 50%.

Where the system is looking for a particular partial state (e.g. a pointing hand) all states that indicate that state (e.g. be it palm up, down or inward) are summed and it is this summed value that is used to determine whether the hand is in that state.

While the classification data may be used to indicate which image element a particular body part (e.g. palm etc.) is in, the classification data may also be used to estimate where particular body parts are in the image. For example, the centre of mass of a body part may be calculated by summing the product of every image element (e.g. pixel) that has been classified as relating to that body part and the classified weight. This sum is then divided by the sum of the weights to produce an estimate of the centre of mass of the body part. In other examples the centre of mass of a body part may be calculated from a clustering technique (e.g. with the mean shift algorithm).

Using the above method to locate arm parts (e.g. palm, wrist, etc.) increases in accuracy as the number of image elements (e.g. pixels) available increases. Accordingly, the centre of the palm may be simply and straightforwardly computed by the above classification method since there are a relatively large number of image elements in a palm. However, locating the position of smaller arm parts (e.g. digit tips, such as the forefinger tip) may be more difficult or less accurate since there are fewer image elements in these parts.

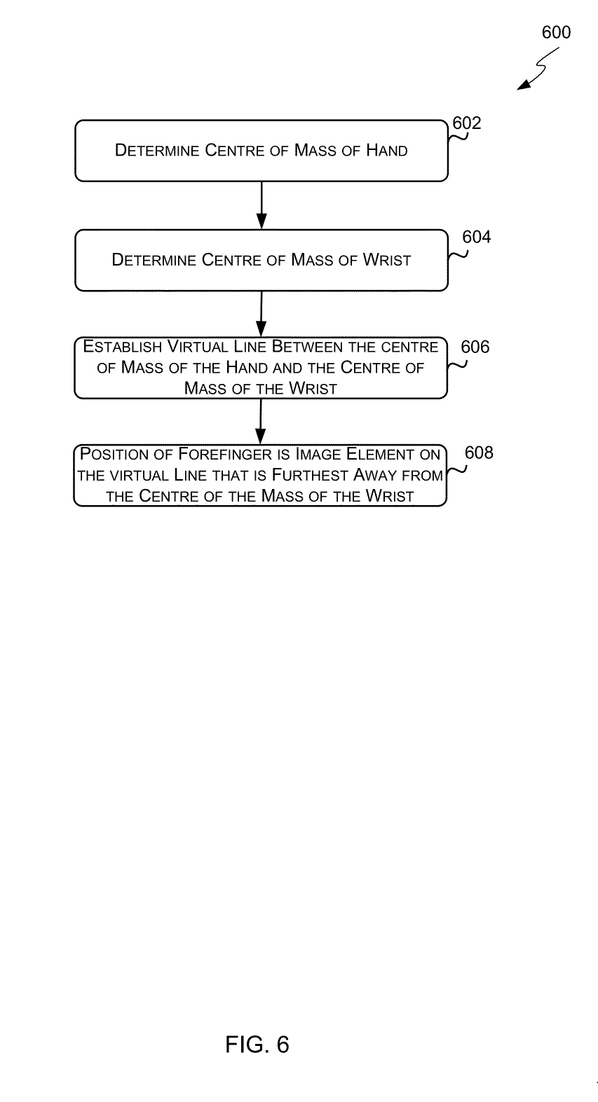

To address this issue, in some examples, the location of certain small body parts (e.g. digit tips, such as the forefinger tip) may be determined from the centre of mass of the hand. An example method for identifying the location of the forefinger tip is described in reference to FIG. 6. Once the location of the forefinger tip has been identified it may be used by the control system 100 as the point at which touch occurs.

The gesture recognition stage 318 detects gestures based on the part and state classification made by the classification stage 316. In some examples, the gesture recognition stage 318 analyzes the part and state classification over a period of time. In particular, discrete gestures (e.g. gestures that involve maintaining one particular state for a period of time) may be identified when the corresponding state is detected in a predetermined number (e.g. three) of consecutive images. Continuous gestures (e.g. gestures that involve more continuous movement, such as touch and dragging on the keyboard) may be identified when a series of states are detected over a predetermined number of consecutive images.

Once the gesture recognition stage 318 has identified that the user has performed or executed a particular gesture, information identifying the particular gesture executed is provided to the computing-based device 102 which may trigger the computing-based 102 device to carry out one or more actions.

In some examples, a gesture is provided to the computing-based device 102 if the gesture is performed in a certain location with respect to a reference object, such as a keyboard. In some examples, the location of the keyboard on the desktop is determined by analyzing a depth or color image of the desktop with the keyboard situated thereon to identify an image element that corresponds to the keyboard (e.g. an image element that meets certain criteria (e.g. it has a depth or color within a predetermined range and is part of an object that meets the criteria)). Once the image element has been identified the corners of the keyboard are identified. The area of the image corresponding to the keyboard is then determined from the corners. Details of methods for identifying the location of a keyboard on a desktop are given in co-pending U.S. patent application “Controlling a computer device using hand gestures” Smyth et al. filed on the same day as this application.

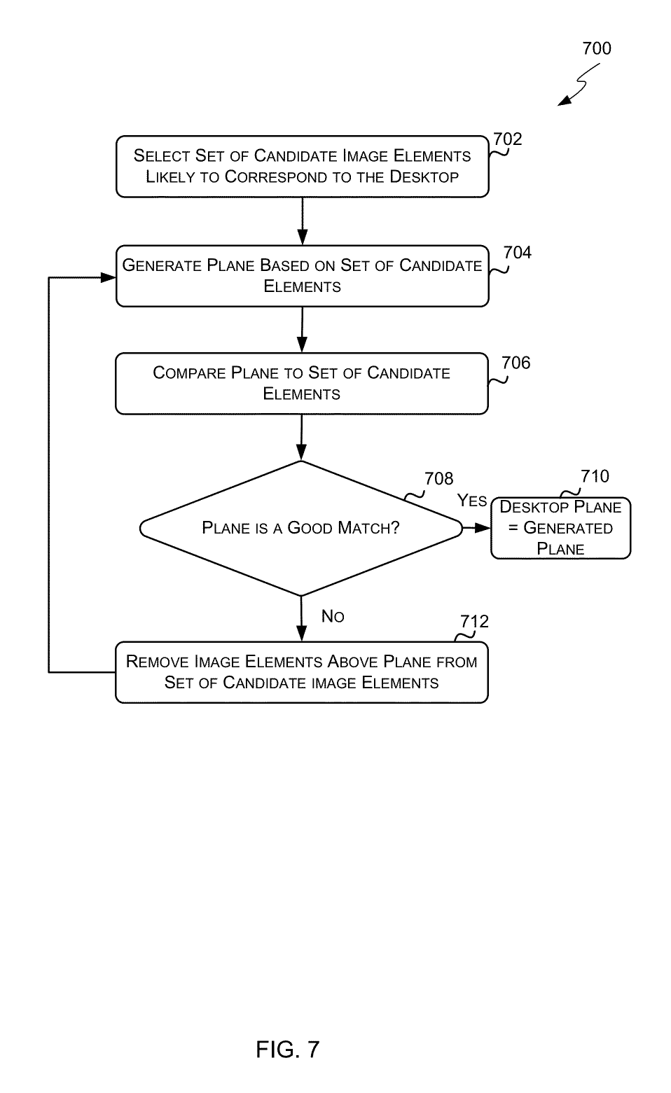

In some examples, identifying the location of the keyboard comprises identifying an object in the image with a predetermined depth from the desktop. In these examples, the plane of the desktop may be first determined. An example method for identifying the plane of the desktop is described in reference to FIG. 7.

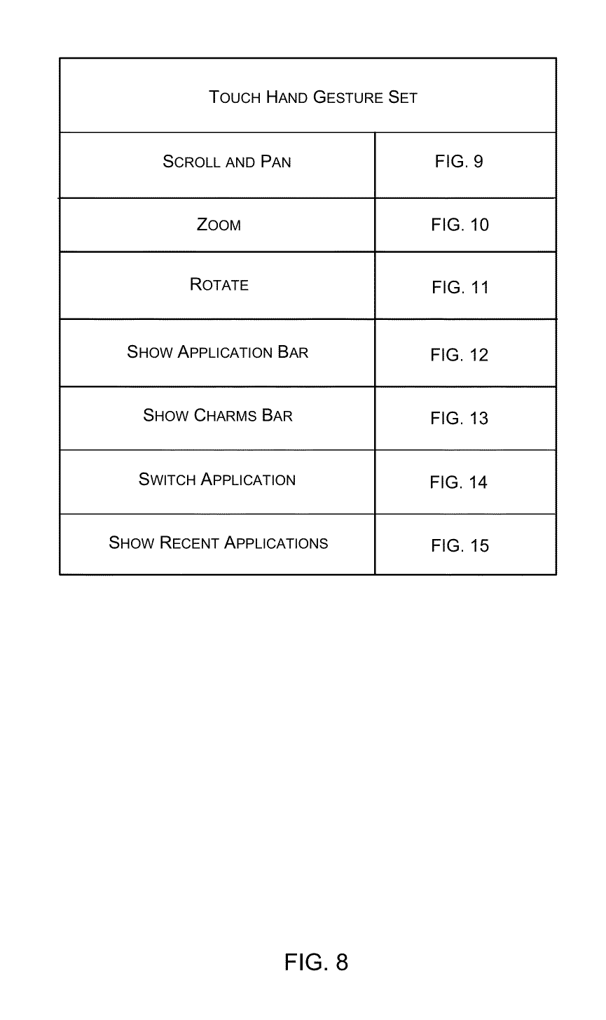

An example gesture set that may be used with the methods and systems described herein is described in reference to FIGS. 8 to 25.

Reference is now made to FIG. 4 which is a flow diagram of a method 400 for detecting the background of an image. In this method 400 each image element of an image is tracked over a predetermined period of time (e.g. 30 seconds). If an image element has moved more than a predetermined threshold during that time then it is deemed to be part of the foreground. Otherwise, the image element is deemed to be part of the background.

At block 402, a first image of the desktop is received from the capture device 110. Once the image has been received the method 400 proceeds to block 404.

At block 404, a second image of the desktop is received from the capture device 110. Once the second image has been received the method 400 proceeds to block 406.

At block 406, the two most recently received images are compared to identify differences between the images. Specifically, on a per-image element (e.g. pixel) basis the differences in the depths depicted at a particular image element are computed and the difference added to a distance counter for that particular image element. In another example, more than two images are compared. For example, for each image element, a histogram is kept of the depths reported for at that image element in a stream of images of a scene captured over a specified period of time. The histogram may be used to set a background value, such as by selecting the maximum depth in the histogram or by taking an average or in other ways.

Once the images have been compared and the distance counters updated the method 400 proceeds to block 408.

At block 408, it is determined whether a predetermined period of time (e.g. 30 seconds) has elapsed since receiving the first image in block 402. The predetermined period is selected to be sufficiently long so that the background is likely to be uncovered. If the predetermined period has elapsed then the method proceeds to block 410. If however, the predetermined period has not elapsed then and the method proceeds back to block 404 to receive another image.

At bock 410, the distance counter for each of the image elements (e.g. pixels) is compared to a predetermined threshold. In some examples, the predetermined threshold is around 10 mm. If a particular distance counter is above the predetermined threshold then the associated image element is deemed to be part of the foreground. If, however, a particular distance counter is below or equal to the predetermined threshold then the associated image element is deemed to be part of the background and is added to the background image.

In this method 400 an object that initially forms part of the foreground may move into the background if it stays at rest (e.g. does not move) for a predetermined period of time. For example, when a user is typing or executing a gesture a user's arms may remain at rest. In such situations the arms may become part of the background and only the hands appear as foreground.

To help ensure that a resting motionless arm does not merge into the background when the corresponding hand is in motion, in some examples, the method 400 may further comprise identifying background image elements (e.g. pixels) adjacent to foreground image elements that are part of the same object. These image elements may then be deemed to be foreground images. Image elements may be deemed to be part of the same object if they have similar depth.

Method 400 may be repeated on a periodic basis so that the background is automatically updated to reflect any changes made to it.

Reference is now made to FIG. 5 which illustrates a flow diagram of a method 500 for identifying objects in an image. The method 500 implements a modified connected component labeling technique that uses the fact that any relevant component (e.g. arms) will start at the edge of the image.

At block 502, an image of the foreground is received from the background segmentation stage 310. Once the image is received the method 500 proceeds to block 504.

At block 504, the first row of image elements (e.g. pixels) in the received image are analyzed to identify runs of adjacent component image elements. The first row of image elements is the row of image elements closest to the user. A run of adjacent component image elements is a group of elements thought to form a component and is referred to herein as a candidate component. It is assumed in this method that there are non-component gaps between components. Accordingly, each run of adjacent components is delimited at each end by an edge of the image or an adjacent non-component image element. Once the first row of image elements have been analyzed to identify runs of adjacent image components, the method 500 continues to block 506.

At block 506, it is determined whether at least one run of adjacent component image elements was identified in block 504. If, at least one run of adjacent component image elements was identified in block 504, the method 500 proceeds to block 508. If, however, no runs of adjacent component image elements were identified in block 504, the method ends.

At block 508, the image elements in each run of adjacent component image elements are linked together into rings. Once the image elements have been linked together into rings, the method 500 proceeds to block 510.

At block 510, the next row in the image is analyzed to identify runs of adjacent component image elements. Once the next row in the image has been analyzed to identify runs of adjacent component image elements, the method 500 proceeds to block 512.

At block 512, it is determined whether at least one run of adjacent component image elements was identified in block 510. If at least one run of adjacent component image elements was identified in 510, then the method 500 proceeds to block 514. If, however, no runs of adjacent component image elements were identified in block 510 then the method ends.

At block 514, for each run of adjacent components image elements identified in block 510 are compared with the runs of adjacent components discovered in the previous row and combined where appropriate.

For example, if one or more runs from a single candidate component are found below a particular run of adjacent components then the particular run of adjacent components is combined with that candidate component. If, however, more than one run from different candidate components are found below a particular run, the particular run is combined with one of the candidate components (e.g. the leftmost candidate component) and the candidate components are combined. Runs that are part of non-candidate components are combined if they are not already combined. Runs that are parts of non-candidate components are combined into the new run's component. If a particular run does not have any runs below it a new non-candidate components is formed.

The candidate components grow upwards from the bottom of the image row-by-row. This is straightforward when the component grows directly upward. Specifically, any run of adjacent components above a candidate component are added to the candidate component. However, in some cases (e.g. an arch) it is not evident that a component is part of a candidate component until the candidate component and the non-candidate components join. Accordingly, when this occurs, the non-candidate component is merged with the candidate component to extend the candidate component. Eventually each non-candidate component is either found to be part of a candidate component or is discarded.

Once the runs of adjacent component image elements identified in block 510 are compared and combined with the runs of adjacent components identified in the previous row, the method 500 proceeds back to block 510.

Reference is now made to FIG. 6 which is a flow diagram of a method 600 for determining the location of a user's forefinger tip. At block 602, the location of the centre of mass of the hand is determined. In some examples, the centre of mass of the hand is determined by summing the product of every image element classified by the classification stage 316 as forming part of the palm and the classified image element weights. The sum is then divided by the sum of the weights to provide an estimate of the centre of mass of the hand. In other examples, the centre of mass of the hand may be determined using a mean-shift mode detection process. Once the centre of mass of the hand has been determined, the method 600 proceeds to block 604.

At block 604, the location of the centre of mass of the wrist is determined. In some examples, the centre of mass of the wrist is determined by summing the product of every image element classified by the classification stage 316 as forming the wrist and the classified image element weights. The sum is then divided by the sum of the weights to provide an estimate of the centre of mass of the wrist. In other examples, the centre of mass of the wrist may be determined using a mean-shift mode detection process. Once the centre of mass of the wrist has been determined the method 600 proceeds to block 606.

At block 606, a virtual line between the centre of mass of the wrist and the centre of mass of the hand is established. Once the virtual line has been established, the method 600 proceeds to block 608.

At block 608, the position of the forefinger tip is estimated to be the image element (e.g. pixel) on the virtual line that is furthest away from the centre of mass of the wrist and is identified as being part of the arm.

Reference is now made to FIG. 7 which is a flow diagram of a method 700 for determining the plane of the desktop. At block 702, a set of candidate image elements are selected from an image of the desktop that are likely to correspond to the desktop. In some examples, the candidate image elements are selected from around the edge of the image since it is likely that the centre of the image is to be occupied by the keyboard. Once the set of candidate image elements are selected, the method 700 proceeds to block 704.

At block 704, a plane is generated based on the current set of candidate image elements. Once the plane has been generated the method 700 proceeds to block 706.

At block 706, the plane generated in block 704 is compared to the set of candidate image elements. At block 708, it is determined whether the plane is a good fit for the candidate image elements. In some examples, a plane is deemed to be a good fit if a predetermined percentage of the image elements are within a predetermined threshold distance of the plane. If the plane is a good fit for the candidate image elements then the method 700 proceeds to block 710. If, however, the plane is not a good fit for the candidate image elements then the method proceeds to block 712.

At block 710, the plane is deemed to be the plane of the desktop.

At block 712, any candidate image elements that appear above the plane are assumed not to be part of the desktop and are removed from the set of candidate image elements. Once the identified image elements are removed from the set of candidate image elements the method proceeds back to block 704.

Reference is now made to FIGS. 8 to 25 which describe a gesture set that may be used with the methods and systems described herein. The gesture set (touch hand gestures and free-air hand gestures) is designed so that the gestures are made on, near or above the reference object (e.g. a keyboard) so that the user can easily transition from providing input via traditional means (i.e. a via a keyboard) to providing input via hand gestures. In examples where the reference object is a keyboard (either a physical keyboard or a soft keyboard) the gesture set may be designed to allow the user to perform the gestures while resting his/her hands directly on the work surface (e.g. desk) or the keyboard itself.

To further enhance the experience for the user the gestures are designed to be low effort, casual, minimize the amount of time the user has to maintain their hands in the air, and minimize movement from the reference object (e.g. keyboard).

In some examples, the hand gestures are designed to complement or augment, instead of replace, traditional (e.g. mouse and keyboard) input commands as it is believed there are aspects of traditional input (e.g. mouse and keyboard input) that are difficult to replace with gestures, such as, keyboard input for high bandwidth text input, and mouse input for precise pointing and selecting.

Reference is now made to FIG. 8 which illustrates an example touch hand gesture set. As described above a touch hand gesture is a predefined action or movement performed by the user's hand or hands while in contact with a surface. The surface may or may not comprise touch sensors. Where a touch hand gesture may be accomplished by performing a predefined action with a single hand, the action may be performed by the user's non-dominant hand allowing the user to continue to use their dominant hand for standard tasks such as typing or mouse control.

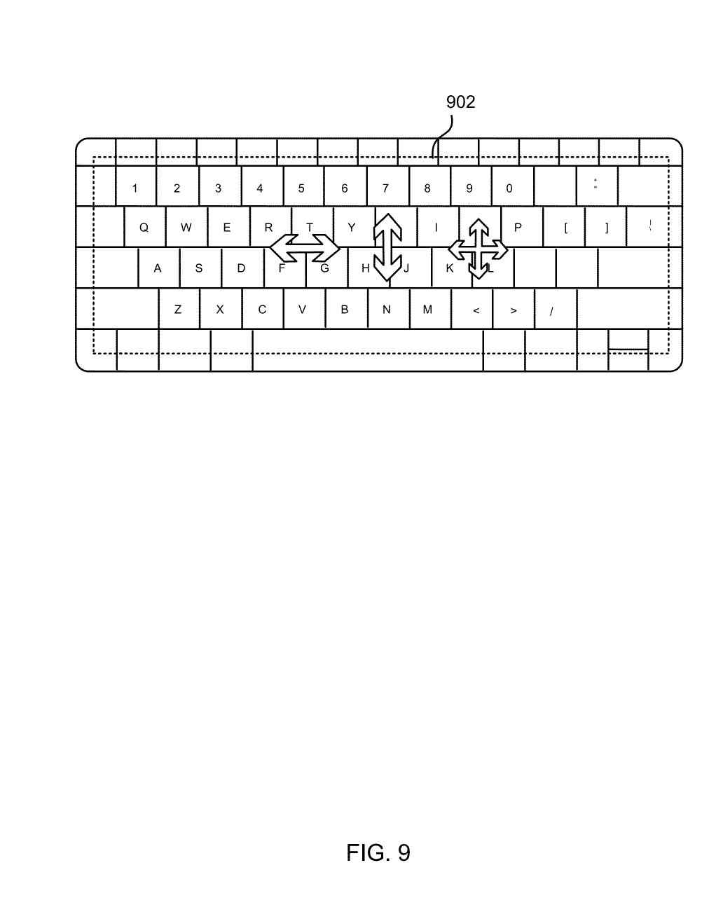

In the example shown in FIG. 8, the touch hand gesture set includes gestures that cause the computing-based device 102 to perform or execute: (1) scrolling and panning; (2) zooming; (3) rotation; (4) showing the application bar; (5) showing the charms bar; (6) switching applications; and (7) showing recent applications. Each of the example touch hand gestures will be described in detail in reference to FIGS. 9-15. In the examples shown and described with respect to FIGS. 9 to 15 the reference object is a keyboard, however, it will be evident to a person of skill in the art that other reference objects may be used.

Reference is now made to FIG. 9 which illustrates an example scroll and pan gesture. In the example of FIG. 9, the scroll and pan gesture is accomplished when one or multiple fingers is/are placed on the surface of the central region of the keyboard and moved in a single linear direction (e.g. left, right, up or down). In some examples, the scroll and pan gesture is recognized if it is initiated in the central region 902 of the keyboard (e.g. not on the edges). In these examples, once the scroll gesture has been initiated in the central region 902 of the keyboard the gesture may continue even if the user's fingers move into the edge region of the keyboard. In some examples, the scroll and pan gesture is recognized if the user has moved their finger or fingers at a minimum speed and/or a minimum amount. In these examples the computing-based device 102 may not detect a scroll and pan gesture until the user's finger(s) has/have moved more than a threshold distance within a predetermined time period.

When the system detects that the user has performed the scroll and pan gesture, the computing-based device 102 may issue a scroll or pan command to the currently active application. The direction of the scrolling or panning may be dictated by the currently active application. For example, if the currently active application only supports vertical scrolling, any scroll gesture in a horizontal direction (e.g. left or right) may be ignored. Similarly, if the currently active application only supports horizontal scrolling, any scroll gesture in a vertical directional (e.g. up or down) may be ignored.

Furthermore, the type of action performed in response to the scroll or pan command may be dictated by the speed at which the user performs the scroll or pan gesture, the position at which the user performs the scroll or pan gesture with respect to the keyboard, and/or the currently active application. For example, in some applications a scroll or pan command may cause the application to scroll or pan the currently active window, whereas in other applications a scroll or pan command may cause the application to execute a page forward or page backward command.

In some examples, the speed at which the user performs the scroll or pan gesture, and/or the size of the scroll or pan gesture performed by the user may dictate the magnitude of the scroll or pan. This allows the user to perform both coarse grain and fine grain scrolling or panning. For example, if the user moves their finger or fingers quickly in one direction, the magnitude of the scroll or pan may be greater than if the user moves their finger or fingers slowly.

In some examples, if the user moves their fingers to a new point on the keyboard while performing the scroll and pan gesture, stops moving their fingers and then lifts their fingers off the keyboard, the computing-based device 102 may cause the currently active application to abruptly stop scrolling or panning when the user's fingers stop moving. Conversely, if the user moves their fingers to a new point on the keyboard while performing the scroll and pan gesture and lifts them off the keyboard while they are still moving, the computing-based device 102 may cause the currently active application to continue scrolling in the direction of the fingers and slowly come to a stop after a predetermined period of time (e.g. a few seconds). The speed at which the scrolling or panning comes to a stop may be dictated by the speed at which the user's fingers were moving when they were lifted off the keyboard.

In some examples, the initiation of a new gesture after performing the scroll and pan gesture may cause the computing-based device 102 to abruptly stop the panning or scrolling.

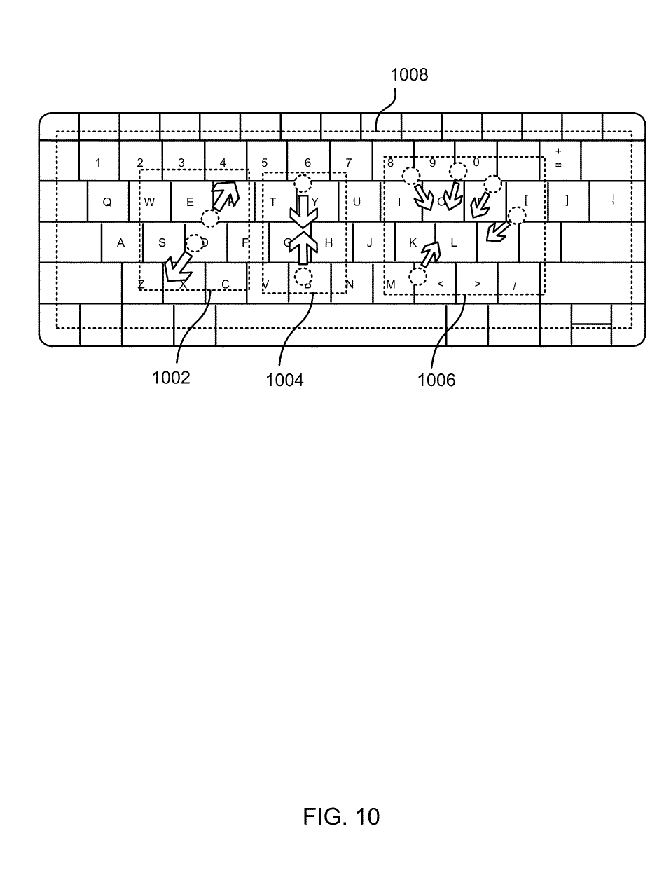

Reference is now made to FIG. 10 which illustrates an example zoom gesture. In this example the zoom gesture is accomplished by making a pinching motion (e.g. bringing two or more fingers together or apart) on the surface of the keyboard. This can be accomplished using two or more fingers on one hand or two hands. In some examples, users can zoom in by bringing their fingers towards one another and zoom out by moving their fingers out from one another. FIG. 10 shows the use of two fingers (e.g. thumb and forefinger) to zoom out 1002, the use of two fingers (e.g. one finger on each hand) to zoom in 1004, and the use of five fingers to zoom in 1006.

In some examples, the zoom gesture is recognized if it is initiated in the central region 1008 of the keyboard (e.g. not on the edges). In these examples, once the scroll gesture has been initiated in the central region 1008 of the keyboard the gesture may continue even if the user's fingers move into the edge region of the keyboard.

In some examples, the speed at which the user moves their fingers toward or away from one another and/or the size of the zoom gesture performed by the user controls the amount or quantity of the zoom. In some examples, the slower the fingers are moved toward or away from one other the smaller the zoom. In contrast, the more quickly the fingers are moved toward or away from one another, the larger the zoom.

When the system detects that the user has preformed the zoom gesture, the computing-based device 102 may issue a zoom command to the currently active application in the direction (e.g. in or out) indicated by the user. If an application receives a zoom command that is not supported it may simply ignore the command.

In some examples, if the user moves their fingers to a new point on the keyboard while performing the zoom gesture, stops moving their fingers and then lifts their fingers off the keyboard, the computing-based device 102 may cause the currently active application to abruptly stop zooming when the user's fingers stop moving. Conversely, if the user moves their fingers to a new point on the keyboard while performing the zoom gesture and lifts them off the keyboard while they are still moving, the computing-based device 102 may cause the currently active application to continue zooming in the direction of the fingers and slowly come to a stop after a predetermined period of time (e.g. a few seconds). The speed at which the zooming comes to a stop may be dictated by the speed at which the user's fingers were moving when they were lifted off the keyboard.

In some examples, the initiation of a new gesture after performing a zoom gesture may cause the computing-based device 102 to abruptly stop the zooming.

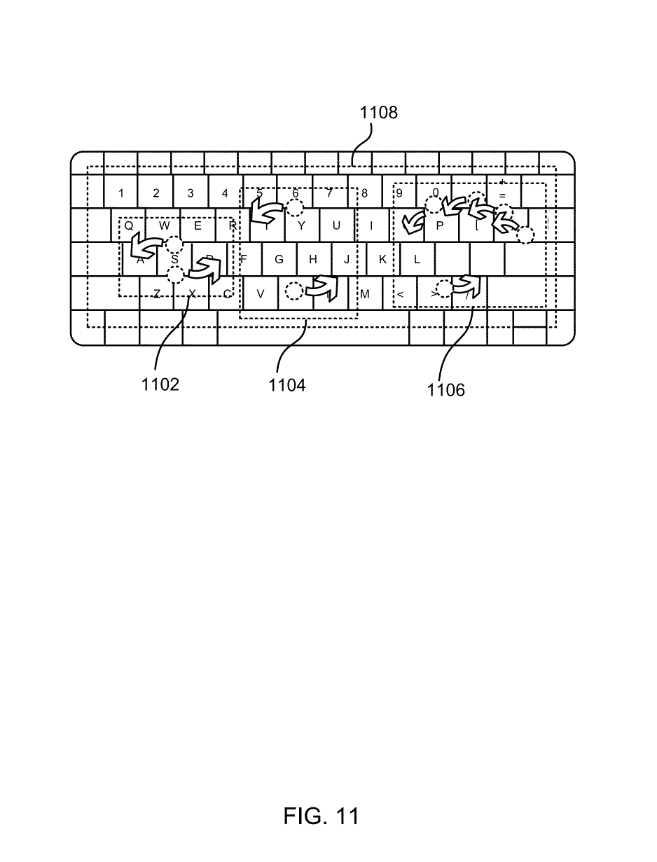

Reference is now made to FIG. 11, which illustrates an example rotation gesture. In this example, the rotation gesture is accomplished by putting two or more fingers on the surface of the keyboard and rotating or twisting them in a common direction (e.g. clockwise or counter-clockwise). The fingers may be from the same hand or different hands. FIG. 11 shows the use of two fingers (e.g. thumb and forefinger) to indicate rotation in the counter-clockwise direction 1102, the use of two fingers (e.g. thumb and forefinger) to indicate rotation in the counter-clockwise direction 1104, and the use of five fingers to indicate rotation in the counter-clockwise direction 1106.

In some examples, the rotation gesture is recognized if it is initiated in the central region 1108 of the keyboard (e.g. not on the edges). In these examples, once the rotation gesture has been initiated in the central region 1108 of the keyboard the gesture may continue even if the user's fingers move into the edge region of the keyboard.

In some examples, the speed at which the user moves their fingers in the direction of rotation and/or the size of the rotation gesture performed by the user controls the amount or quantity of the rotation. This allows the user to perform coarse grain and fine grain rotation. In some examples, the slower the fingers are moved in the direction of rotation, the smaller the rotation; and the more quickly the fingers are moved in the direction of rotation, the larger the rotation.

When the system detects that the user has performed the rotation gesture, the computing-based device 102 may issue a rotation command or instruction to the currently active application. The direction of rotation specified in the command may be the direction (e.g. clockwise or counter-clockwise) indicated by the user. If an application receives a rotation command that is not supported it may simply ignore the command.

In some examples, once a zoom gesture has been initiated any movement of the fingers in a particular linear or rotational direction en-masse may be interpreted as a pan or a rotation. This allows users to fluidly pan, zoom and/or rotate at the same time. For example, if the user moves their fingers en-mass in a particular linear direction while also bringing them closer together, the computing-based device 102 may issue both zoom and pan commands to the currently active application. Similarly, if the user moves their fingers en-mass in a particular rotational direction while also bringing them closer together, the computing-based device 102 may issue both rotation and zoom commands to the currently active application.

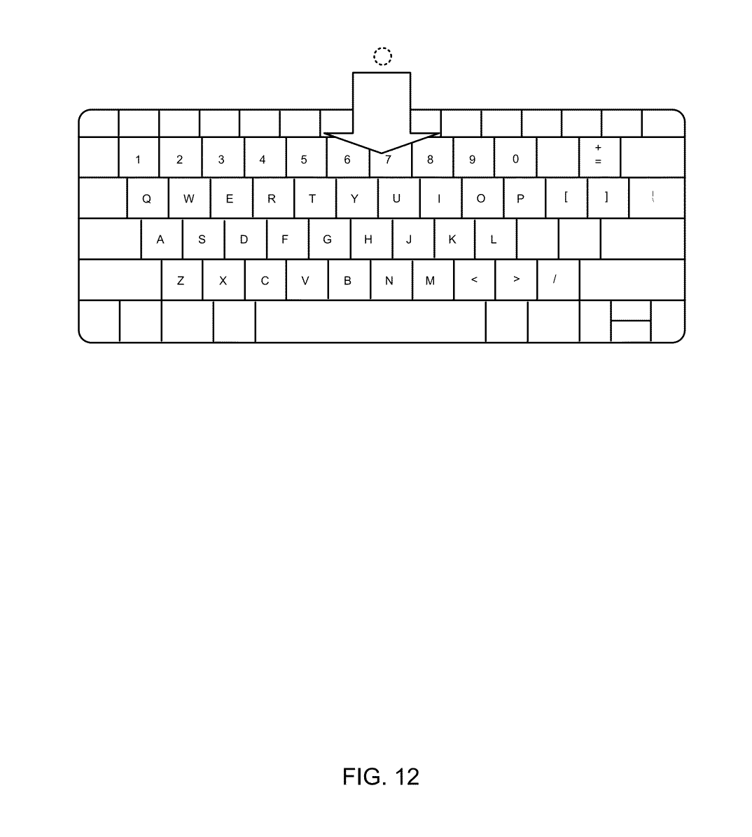

Reference is now made to FIG. 12, which illustrate an example show application bar gesture. In this example, the show application bar gesture is accomplished by swiping the surface (e.g. desk) above the top of the keyboard towards the centre of the keyboard.

When the system detects that the user has performed the show application bar gesture while the computing-based device 102 is operating in a Windows™ environment, the computing-based device 102 may cause the context-sensitive application bar to be displayed to the user.

In some examples, completing the reverse of the show application bar gesture (e.g. swiping the top of the keyboard toward the surface of the desk above the top of the keyboard) may cause the computing-based device 102 to close, retract or hide the application bar. In some examples, if the user does not interact with the application bar, but instead starts a new gesture or clicks somewhere else, the computing-based device 102 may automatically close, retract or hide the application bar.

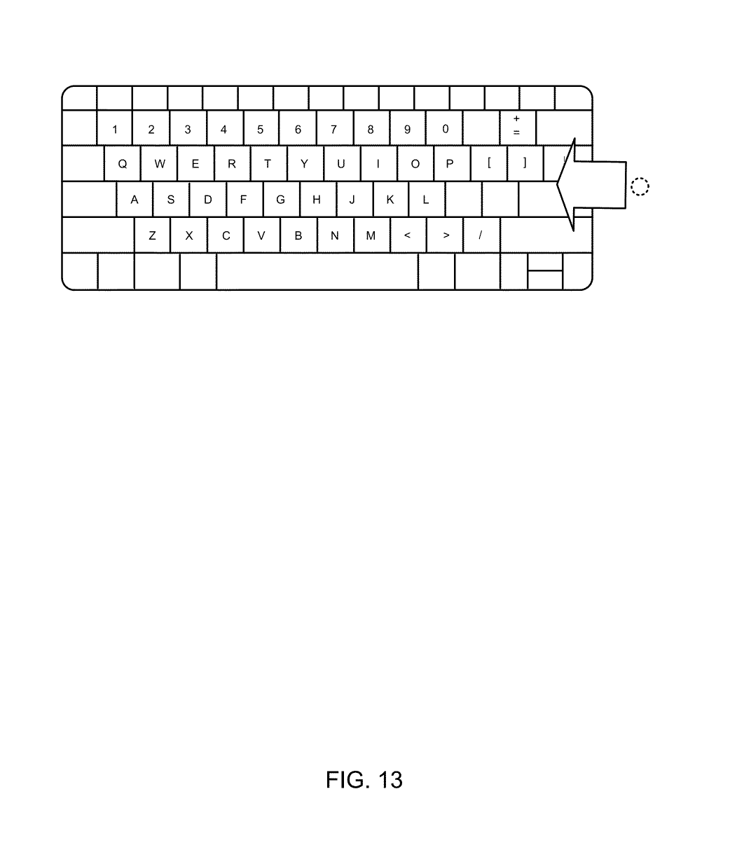

Reference is now made to FIG. 13, which illustrate an example show charm bar gesture. In this example, the show charm bar gesture is accomplished by swiping the surface (e.g. desk) to the right of the keyboard towards the centre of the keyboard.

When the system detects that the user has performed the show charm bar gesture and the computing-based device 102 is operating in a Windows™ environment, the computing-based device 102 may cause the charms bar to be displayed the user.

In some examples, completing the reverse of the show charms bar gesture (e.g. swiping the right side of the keyboard toward the surface to the right of the keyboard) may cause the computing-based device 102 to close, retract or hide the charms bar. If, however, the user does not complete the reverse of the show charms bar, but instead they lift their hand from the keyboard, then the computing-based device 102 may allow the charms bar to remain visible.

In some examples, if the user does not interact with the charms bar, but instead starts a new gesture or clicks somewhere else, the computing-based device 102 may automatically close, retract or hide the charms bar.

In some examples, once the charms bar is visible to the user, the user may be able to highlight different items on the charms bar by moving their fingers up or down on the right-side of the keyboard. For example, if the user moves their fingers towards the top of the keyboard, the computing-based device 102 may highlight the next item above the currently highlighted item; and if the user moves their fingers towards the bottom of the keyboard, the computing-based device 102 may highlight the next item below the currently highlighted item. Once an item has been highlighted, the user may be able to activate or trigger the highlighted item by lifting their fingers off the keyboard.

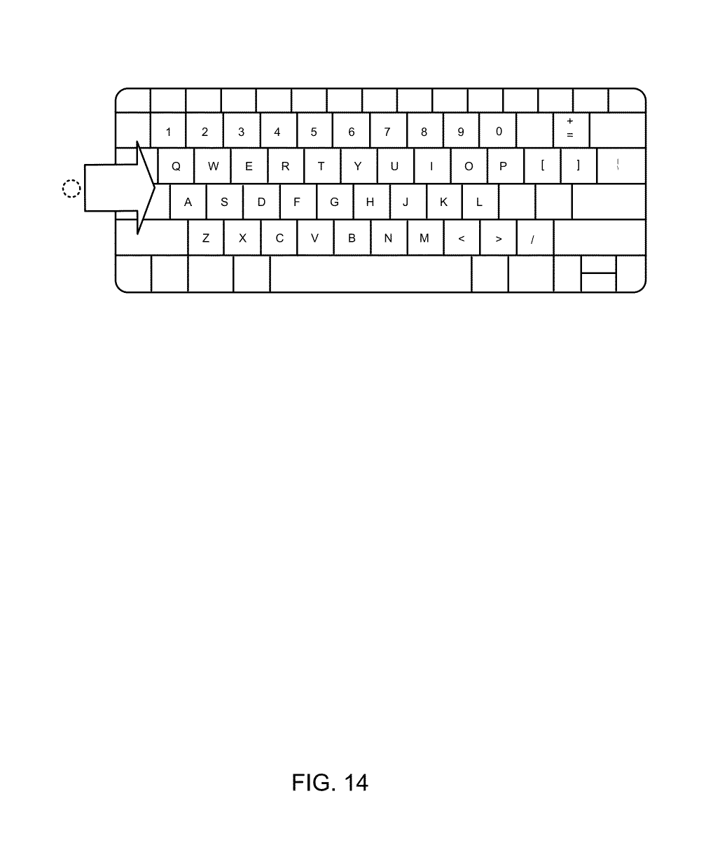

Reference is now made to FIG. 14, which illustrates an example switch application gesture. In this example, the switch application gesture is accomplished by swiping the surface (e.g. desk) to the left of the keyboard towards the centre of the keyboard.

When the system detects that the user has performed the switch application gesture, the computing-based device 102 may cause the most recently accessed open application (other than the currently actively application) to be brought the forefront. If only one application is currently open then the computing-based device 102 may ignore the switch application gesture.

In some examples, repeating the switch application gesture allows the user to scroll through the open windows/applications.

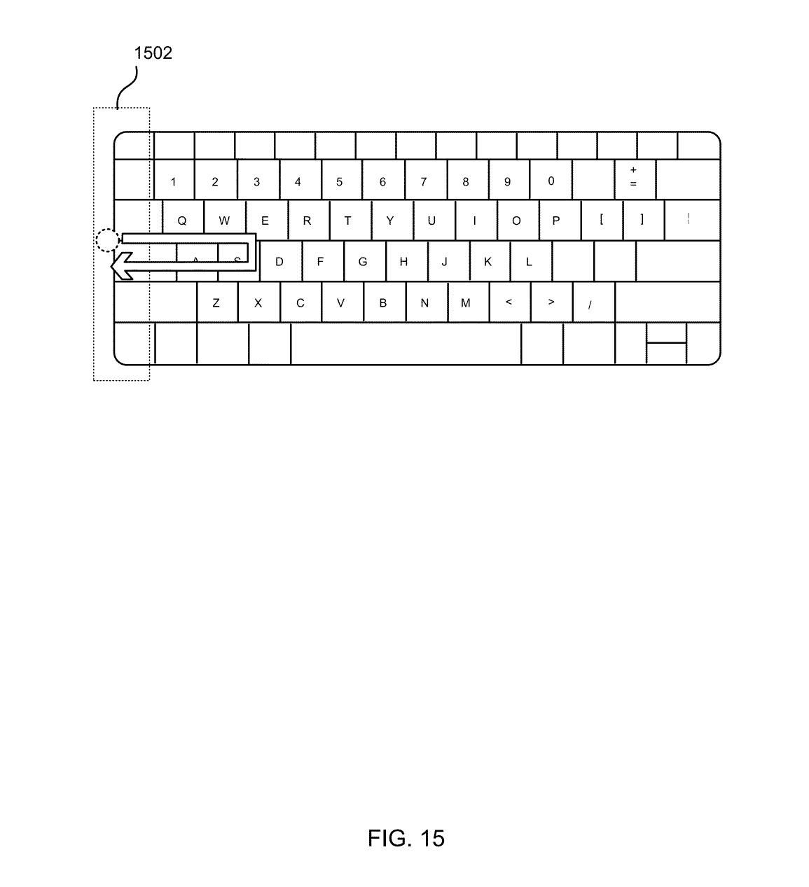

Reference is now made to FIG. 15, which illustrates an example of a show recent application gesture. In this example, the recent application gesture is accomplished by swiping a finger in from the left side 1502 of the keyboard toward the centre of the keyboard and then back out to the left side 1502 of the keyboard.

When the system detects that the user has performed the show recent application gesture, the computing-based device 102 may cause a list of the recently accessed applications to be displayed to the user. In some examples, the list will appear on left hand side of the display.

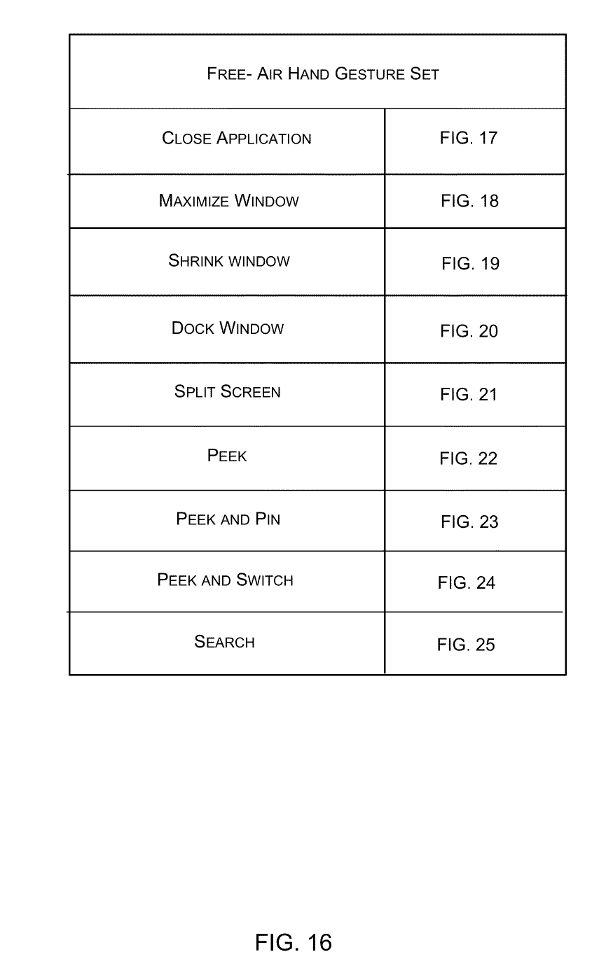

Reference is now made to FIG. 16, which illustrates an example free-air gesture set. As described above a free-air gesture is a predetermined action performed by one or more hands in the air over a reference object without touching a surface.

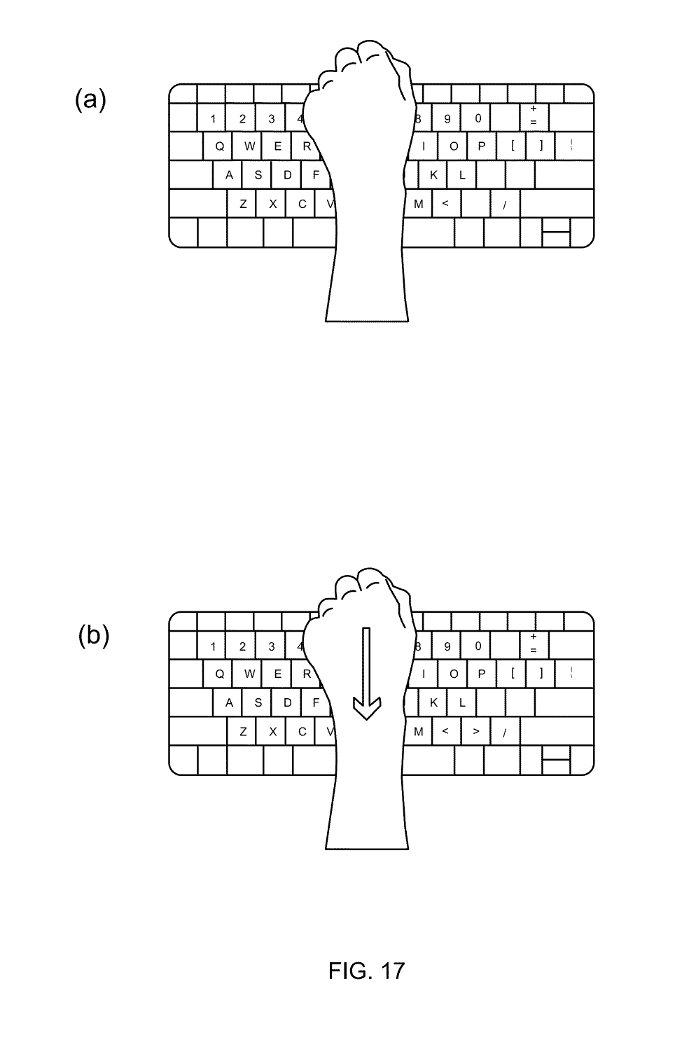

In the example shown in FIG. 16, the free-air hand gesture set includes gestures that will cause the computing-based device 102 to perform or execute: (1) closing of an application; (2) maximizing a window; (3) shrinking a window; (4) docking a window; (5) splitting the screen; (6) peeking at a non-active application; (7) peeking and pining a non-active application; (8) peeking and switching to a non-active application; and (9) searching. Each of these gestures will be described in detail with reference to FIGS. 17 to 25. In the examples shown and described with respect to FIGS. 17 to 25 the reference object is a keyboard, however, it will be evident to a person of skill in the art that other reference objects may be used.

Reference is now made to FIG. 17, which illustrates an example close application gesture. In this example, the close application gesture is accomplished by completing the following actions above the keyboard: (a) placing a closed hand (e.g. first) with the palm down over the keyboard; and (b) moving the hand down (while in a first) vertically towards the bottom of the keyboard. Action (a) is intended to simulate grabbing the application and action (b) is intended to simulate closing the application.

When the system detects that the user has performed the close application gesture, the computing-based device 102 may cause the currently active window/application to be closed.

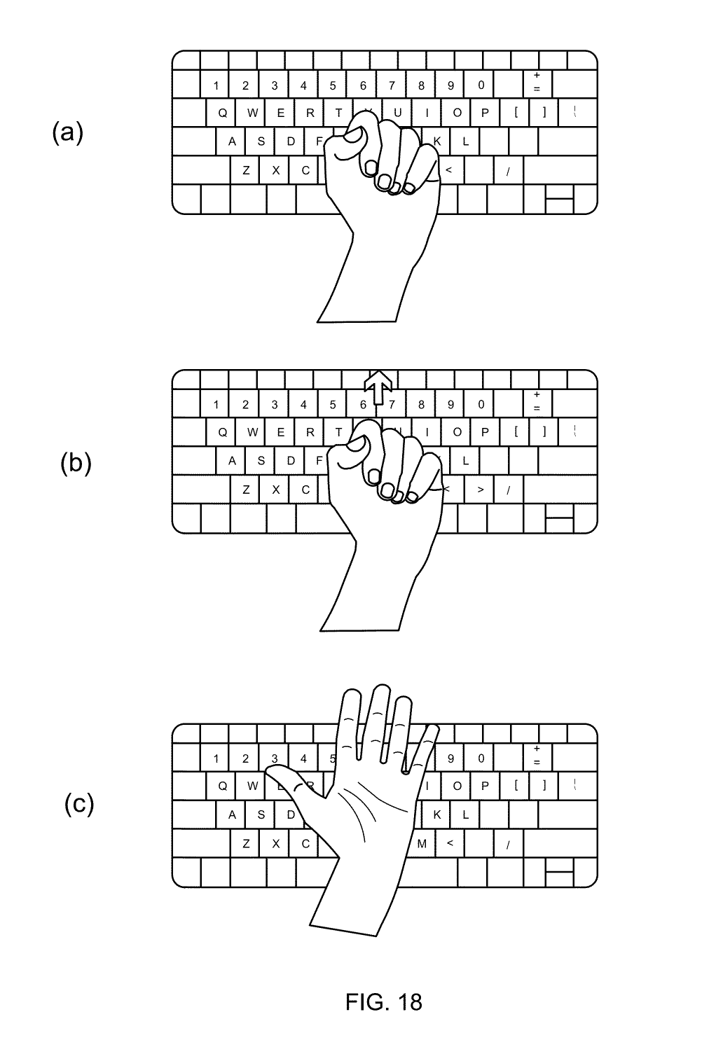

Reference is now made to FIG. 18, which illustrates an example maximize window gesture. In this example, user can accomplish the maximize window gesture by completing the following actions above the keyboard: (a) placing a closed hand (e.g. fist), palm up over the keyboard; (c) moving the hand (while in a first) up vertically towards the top of the keyboard; and (c) opening the hand so that the fingers are stretched out. Action (a) is intended to simulate grabbing the application; action (b) is intended to simulate making the window bigger; and action (c) is intended to confirm the maximization.

When the system detects that the user has preformed the maximize window gesture, the computing-based device 102 may cause the currently active window/application to be maximized.

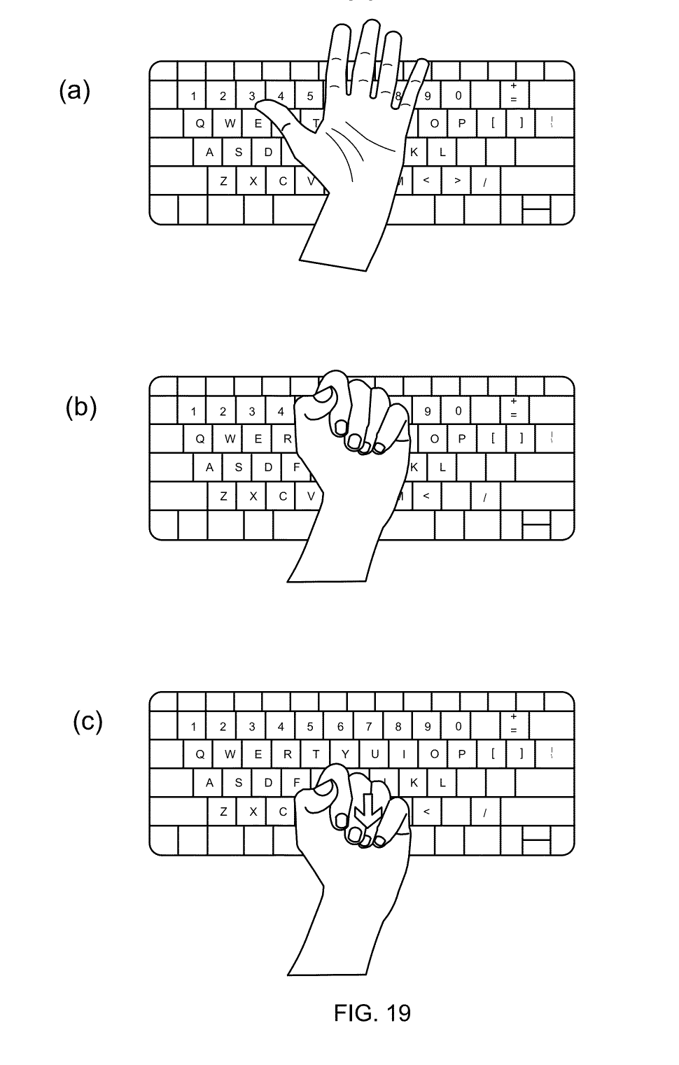

Reference is now made to FIG. 19, which illustrates an example shrink window gesture. In this example, the user can accomplish the shrink window gesture by completing the following actions above the keyboard: (a) placing a hand over the keyboard with the palm up and fingers stretched out; (b) closing the hand to make a fist; and (c) moving the hand (while in a first) vertically down towards the bottom of the keyboard. Actions (a) and (b) are intended to simulate grabbing the application; and action (c) is intended to simulate making the window smaller.

When the system detects that the user has preformed the shrink window gesture, the computing-based device 102 may cause the currently active window/application to shrink. The amount of shrinkage may be based on the state of the window/application when the gesture is made. For example, if the window was in the maximized state when the gesture was made, the computing-based device 102 may take the window back to its restored state. Alternatively, if the window was in the restored state when the gesture was made, the system may minimize the window.

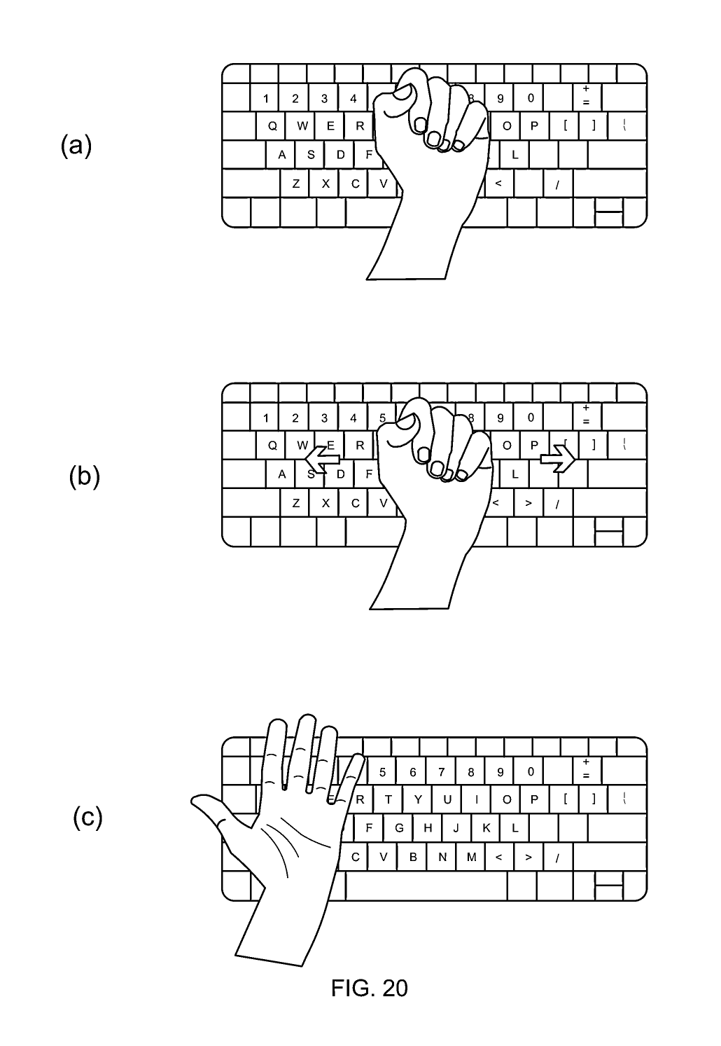

Reference is now made to FIG. 20, which illustrates an example dock window gesture. In this example, the user can accomplish the dock window gesture by completing the following actions above the keyboard: (a) placing a closed hand (e.g. fist), palm up over the keyboard; (b) moving the hand (while in a first) horizontally towards the left or right side of the keyboard; and (c) opening the hand so that the fingers are stretched out. Action (a) is intended to simulate grabbing the application; action (b) is intended to simulate moving the window to the left or the right; and action (c) confirms the action or command.

When the system detects that the user has preformed the dock window gesture, the computing-based device 102 may cause the currently active window/application to be docked. “Docking”, refers to the Windows™ operating system idiom of repositioning a window/application to fit into the left or right hand side of the screen. When a window/application is docked it is typically given the full height of the screen, but only a portion of the width of the screen. The width given to a docked window/application may be set by Windows™ and is typically half or less than half of the screen. The application is docked to the left or to the right based on the direction in which the user moved their hand while closed (e.g. in a fist).

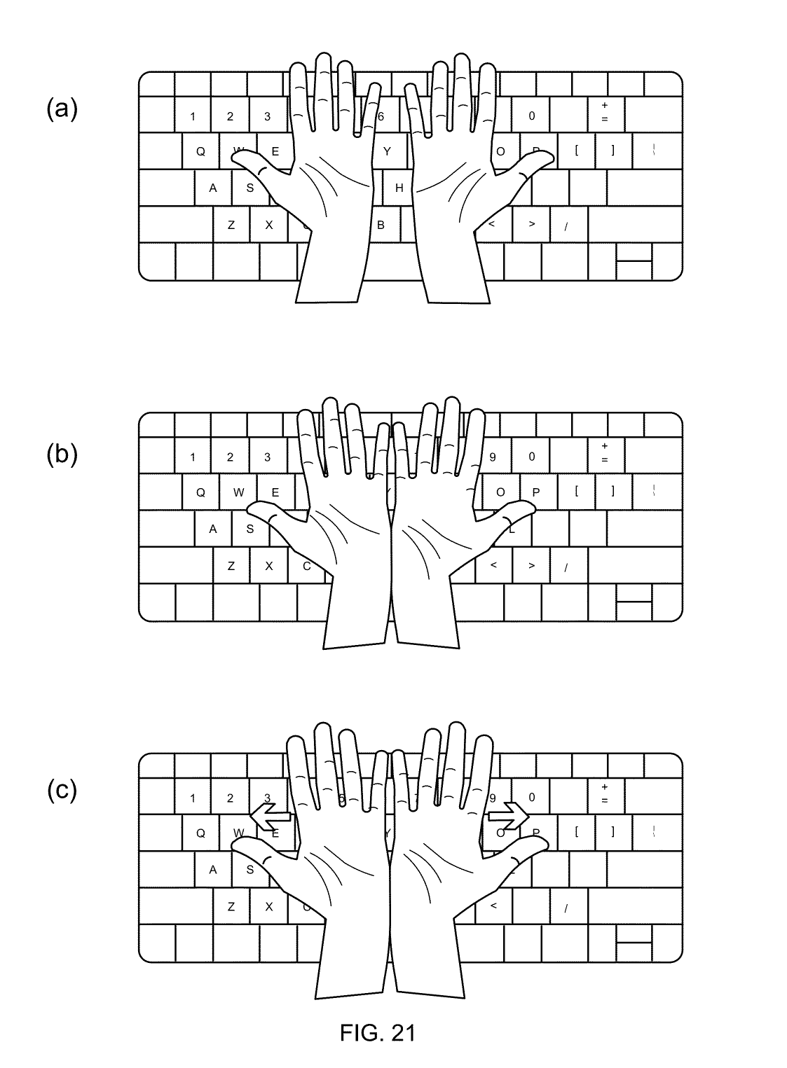

Reference is now made to FIG. 21, which illustrates an example split screen gesture. In this example, the user can accomplish the split screen gesture by completing the following actions above the keyboard: (a) placing both hands palm up and fingers out over the keyboard; and (b) moving the hands together so that the sides of the hands are touching.

When the system detects that the user has preformed the split screen gesture, the computing-based device 102 may cause the two most recently accessed open windows/applications to be tiled side by side. If there is a currently active window/screen displayed at the time the split screen gesture is performed, then the computing-based device 102 may tile the currently active screen with the next most recently active open window/application side by side. If, however, there are no currently active windows (e.g. all the applications have been minimized) at the time the split screen gesture is performed, then the computing-based device 102 may tile the two most recently accessed open windows/applications side by side. Where there are no open windows/applications, or only one open window/application, at the time the split screen gesture is performed the computing-based device 102 may ignore the split screen gesture.

In some examples, if the user immediately repeats the split screen gesture, the computing-based device 102 may cause the tiled windows/applications to return the state they were in prior to being tiled.

In some examples, the computing-based device 102 may automatically split the screen evenly between the two most recently active windows/applications. In other examples, however, the computing-based device 102 may unevenly split the screen between the two most recently active windows/applications. For example, the currently active window/application may be given a larger portion of the screen and the recently active window/application may be given a smaller portion of the screen.

In some examples, after the user has performed the split screen gesture they may adjust the position of the spit between the two windows/applications by performing the following action above the keyboard: (c) while the hands are still palm up and touching, moving both hands to the right or the left side of the keyboard. In some examples, moving the hands to the right indicates that the window/application on the left is to be made larger and the window/application on the right is to be made smaller. Conversely, moving the hands to the left may indicate that the window/application on the right is to be made larger and the window/application on the left is to be made smaller.

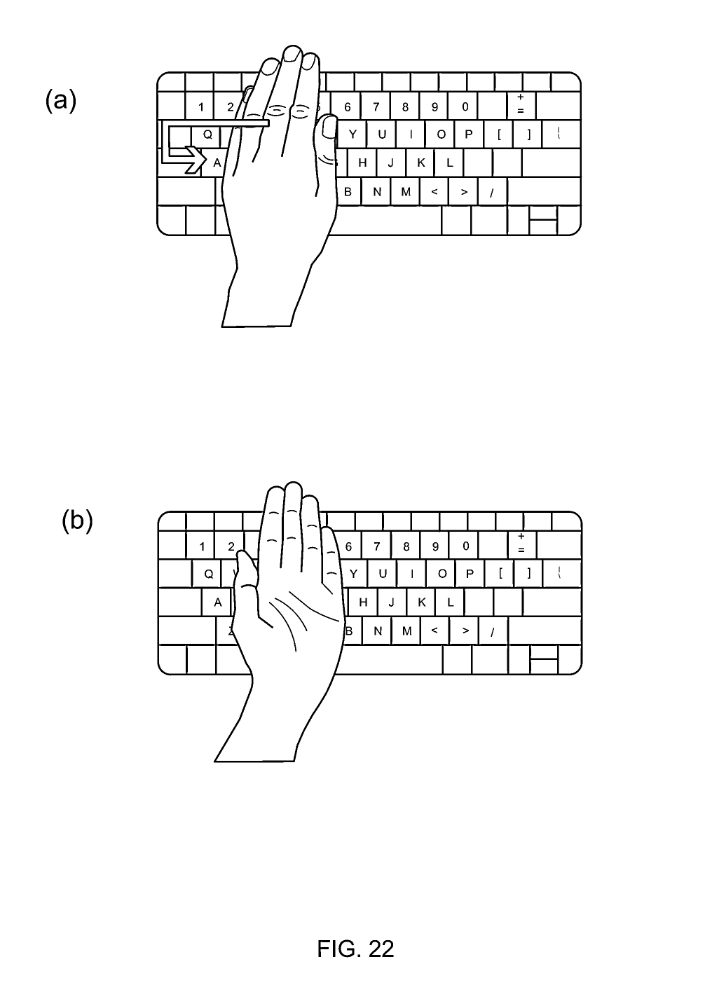

Reference is now made to FIG. 22, which illustrate an example peek gesture. In this example, the user can accomplish the peek gesture by completing the following actions anywhere above the keyboard: (a) placing a hand, palm down, fingers out over the keyboard; and (b) flipping the hand over so that the hand is now palm up, fingers out. The user's fingers may be together, as shown in FIG. 22, or apart (i.e. splayed) when they perform actions (a) and/or (b).

When the system detects that the user has performed the peek gesture, the computing-based device 102 may cause the most recently accessed window/application to be brought the forefront. In effect the peek action simulates the ALT-TAB or WIN-TAB function provided by a Windows™ operating system.

In some examples, as soon as the user puts their palm down again the computing-based device 102 returns the user to their primary application (e.g. the window/application that was active prior to performing the peek gesture). This allows the user to quickly look at a secondary window/application and then rapidly and easily return back to the primary application. This allows users to work in one application or document while quickly glancing at another. For example, the user might be working in a text-editor on a report, while referring to items in a web-page or another document on a recurring basis.

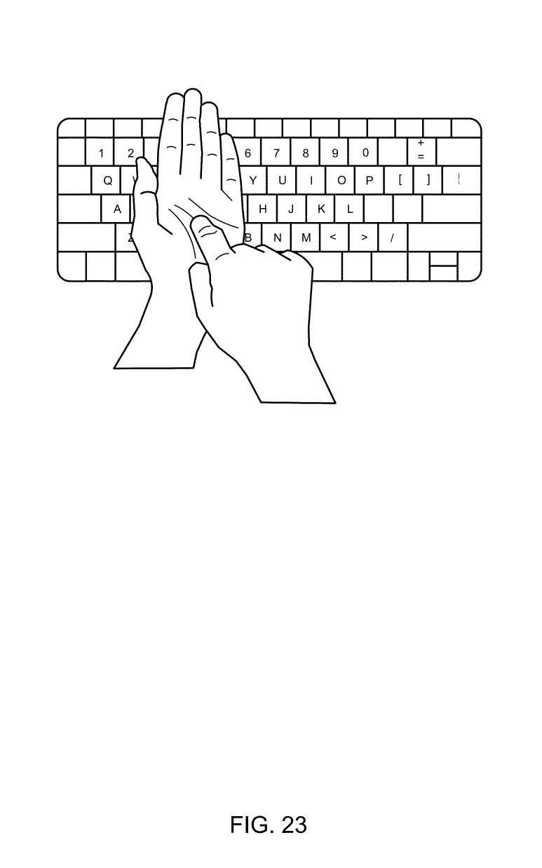

Reference is now made to FIG. 23, which illustrates an example peek and pin gesture. In this example, the user can accomplish the peek and pin gesture by completing the following action anywhere over the keyboard after they have completed a peek gesture: touch the centre of the face up palm with a finger of the other hand.

When the system detects that the user has performed a pin gesture after performing a peek gesture, the computing-based device 102 may “pin” the secondary application (the window/application that became visible as a result of performing the peek gesture). This allows the user to remain in the currently active window instead of being returned the window/application that was active when the peek action was performed (even if the user puts their palm down).

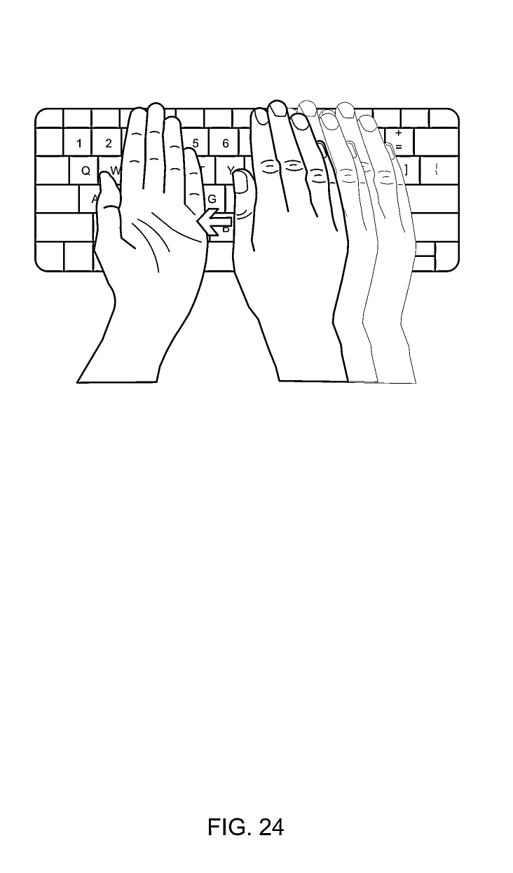

Reference is now made to FIG. 24, which illustrates an example peek and switch gesture. In this example, the user can accomplish the peek and switch gesture by completing the following action anywhere over the keyboard after they have performed a peek gesture: placing the other hand, palm down, fingers out and together over the keyboard and moving it towards the hand that was used to perform the peek action.

When the system detects that the user has performed a peek and switch gesture after performing a peek gesture, the computing-based device 102 may cause the next most recently accessed open window/application to be brought to the forefront. In some examples, each time the user performs the peek and switch gesture, the next most recently accessed open application is brought to the forefront. This allows the user to quickly scroll through the open applications. In some examples, when the user stops the peek and switch gesture or stops the peek gesture the user remains with the currently active window, they are not brought back to a previously active window (e.g. the window/application that was active when the peek gesture was performed) like when the peek gesture is performed on its own.

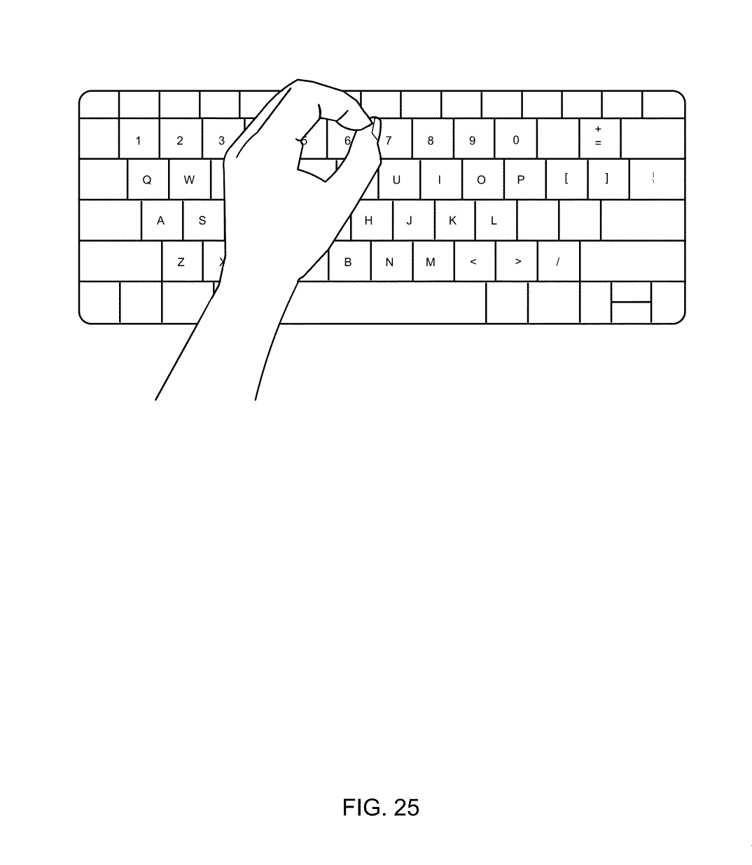

Reference is now made to FIG. 25, which illustrates an example search gesture. In this example, the user can accomplish a search gesture by performing the following action anywhere over the keyboard: making an “o” shape with one of their hands.

When the system detects that the user has made the search gesture, the computing-based device 102 may cause a context sensitive search to be initiated in the currently active application/window.

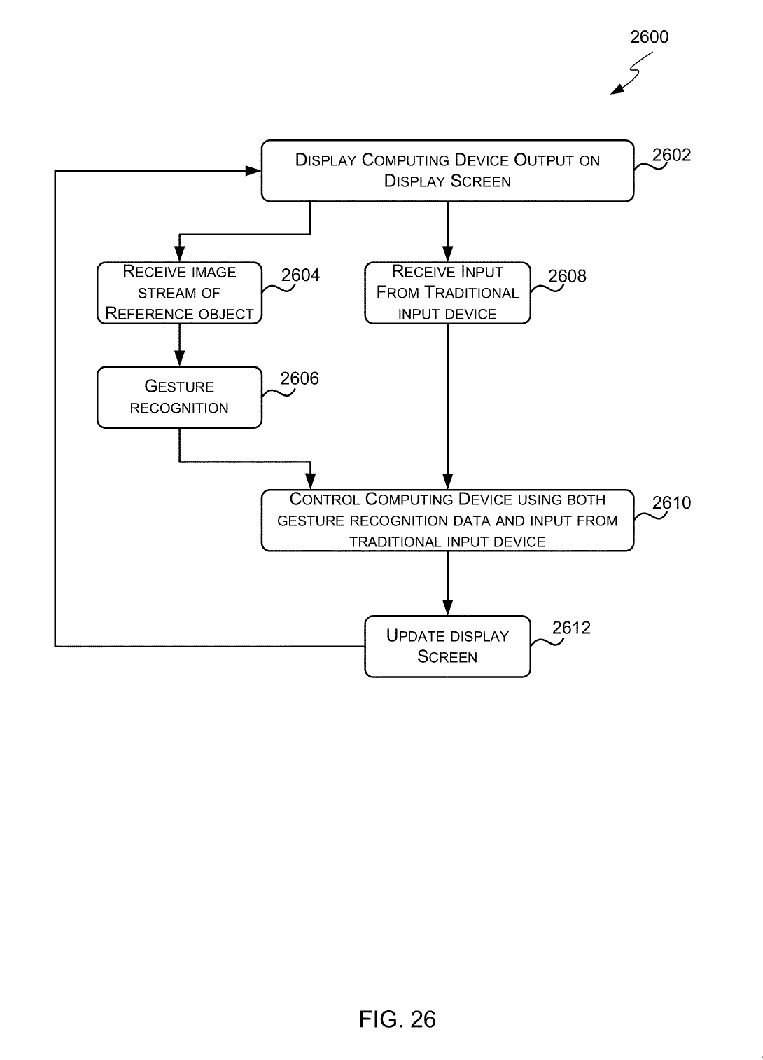

Reference is now made to FIG. 26 which illustrates a flow diagram of a method 2600 for controlling a computing-based device 102 using a combination of traditional (e.g. keyboard and mouse) control and hand gesture control. At block 2602 the display output of the computing-based device 102 is displayed on the display screen 106. At block 2602 an image stream is received depicting the reference object (e.g. keyboard) and the area immediately surrounding the reference object. For example, the image stream may be obtained from the capture device 110 and may comprise depth images and color images. At block 2606 gesture recognition is carried out on the image stream, for example, using the gesture recognition engine 212. In addition, at block 2608 input from an input device 108 (e.g. keyboard) is received. At block 2610 the output of the gesture recognition process performed at block 2606 and the traditional input received at block 2608 are used to control the operation of the computing-based device 102. At block 2612 the display device 106 is updated to reflected any changes instigated by the traditional input and/or gesture recognition output. By enabling control of the computing-based device 102 by both traditional inputs (e.g. keyboard and mouse) and gesture input the user has improved control over the computing-based device 102.

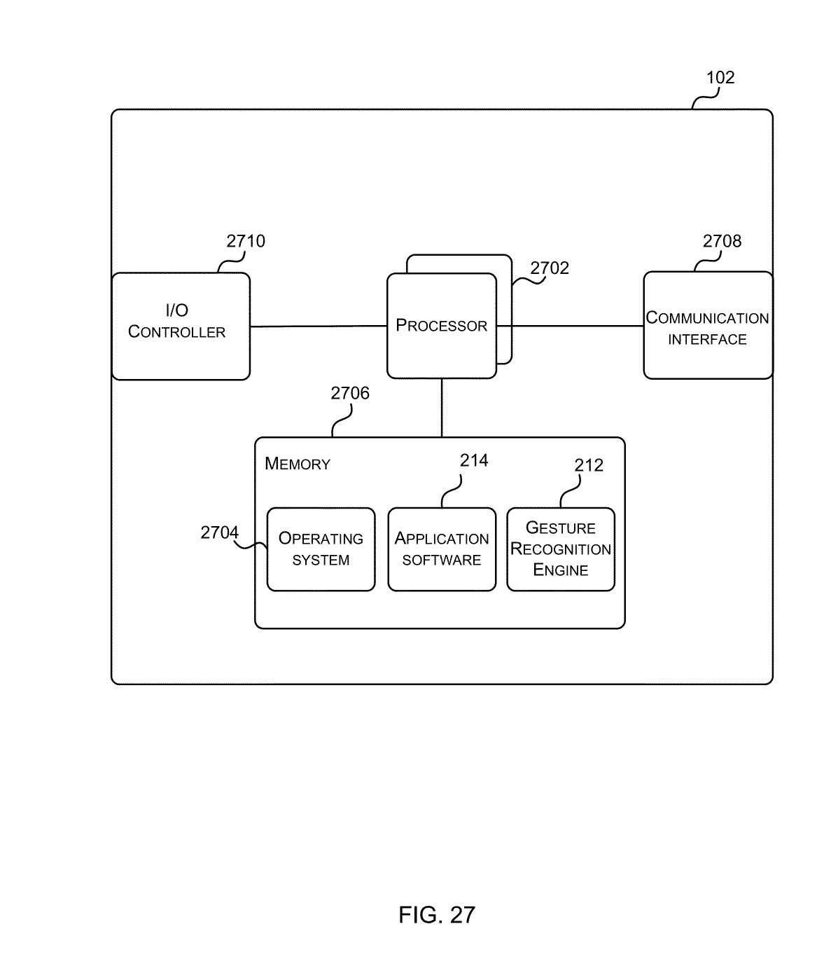

FIG. 27 illustrates various components of an exemplary computing-based device 102 which may be implemented as any form of a computing and/or electronic device, and in which embodiments of the systems and methods described herein may be implemented.

Computing-based device 102 comprises one or more processors 2702 which may be microprocessors, controllers or any other suitable type of processors for processing computer executable instructions to control the operation of the device in order to detect hand gestures performed by the user and to control the operation of the device based on the detected gestures. In some examples, for example where a system on a chip architecture is used, the processors 2702 may include one or more fixed function blocks (also referred to as accelerators) which implement a part of the method of controlling the computing-based device in hardware (rather than software or firmware). Platform software comprising an operating system 2704 or any other suitable platform software may be provided at the computing-based device to enable application software 214 to be executed on the device.

The computer executable instructions may be provided using any computer-readable media that is accessible by computing based device 102. Computer-readable media may include, for example, computer storage media such as memory 2706 and communications media. Computer storage media, such as memory 2706, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing-based device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 2706) is shown within the computing-based device 102 it will be appreciated that the storage may be distributed or located remotely and accessed via a network or other communication link (e.g. using communication interface 2708).

The computing-based device 102 also comprises an input/output controller 2710 arranged to output display information to a display device 106 (FIG. 1) which may be separate from or integral to the computing-based device 102. The display information may provide a graphical user interface. The input/output controller 2710 is also arranged to receive and process input from one or more devices, such as a user input device 108 (FIG. 1) (e.g. a mouse, keyboard, camera, microphone or other sensor). In some examples the user input device 108 may detect voice input, user gestures or other user actions and may provide a natural user interface (NUI). In an embodiment the display device 106 may also act as the user input device 108 if it is a touch sensitive display device. The input/output controller 2710 may also output data to devices other than the display device, e.g. a locally connected printing device (not shown in FIG. 27).

The input/output controller 2710, display device 106 and optionally the user input device 108 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs) and Graphics Processing Units (GPUs).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of controlling a computing-based device, the method comprising:
receiving input from a traditional input device;
receiving an image stream of a reference object;
performing gesture recognition on the received image stream to identify hand gestures performed on or near the reference object; and
controlling the computing-based device using both the input received from the traditional input device and the identified hand gestures.

2. The method according to claim 1, wherein the hand gestures comprise at least one touch hand gesture.

3. The method according to claim 1, wherein the hand gestures comprise at least one free-air hand gesture.

4. The method according to claim 1, wherein the hand gestures comprise at least one touch hand gesture and at least one free-air hand gesture.

5. The method according to claim 1, wherein the reference object is a keyboard.

6. The method according to claim 1, wherein performing gesture recognition on the received image stream comprises identifying the background of the received image stream, wherein identifying the background of the received image stream comprises deeming an image element of the received image stream to be part of the background if the object associated therewith does not move a predetermined distance within a predetermined period.

7. The method according to claim 1, wherein performing gesture recognition on the received image stream comprises performing connected component analysis on at least a part of the image stream to identify components that have at least one image element that lies on a front edge of the image stream.

8. The method according to claim 1, wherein performing gesture recognition on the received image stream comprises detecting at least one arm in the received image stream, wherein the at least one arm is detected by identifying an object in the image stream that has at least one image element that lies on a front edge of the image stream and is greater than a predetermined threshold size.

9. The method according to claim 1, wherein performing gesture recognition on the received image stream comprises applying a classifier to at least a portion of the image elements of the received image stream to classify each image element of the portion of image elements as being part of at least one of a particular body part and a particular state.

10. The method according to claim 9, wherein the classifier is trained using images of at least one synthetic hand and at least one real hand.

11. The method according to claim 9, wherein the classifier produces classification data for each image element of the portion of image elements, the classification data indicting the probability that the image element is part of each of a plurality of possible body parts and each of a plurality of possible states.

12. The method according to claim 11, wherein performing gesture recognition on the received image stream further comprises identifying the location of the centre of mass of a particular body part using the classification data.

13. The method according to claim 12, wherein identifying the centre of mass of the body part comprises summing the product of the location of each image element identified as relating to the body part and the probability that the image element is part of the body part divided by the sum of the probabilities that the image element is part of the body part.

14. The method according to claim 11, wherein performing gesture recognition on the received image stream further comprises identifying the location of a user's digit tip, wherein identifying the location of the user's digit tip comprises:
determining the centre of mass of the user's hand;
determining the centre of mass of the user's wrist;
establishing a virtual line between the centre of mass of the hand and the centre of mass of the wrist; and
deeming the user's digit tip to be the image element on the virtual line that is furthest away from the centre of mass of the wrist.

15. The method according to claim 1, wherein performing gesture recognition on the received image stream comprises identifying the plane of a desktop on which the reference object is situated, wherein identifying the plane of the desktop comprises identifying a set of candidate image element likely to correspond to the desktop and iteratively generating a plane and modifying the set of candidate image elements until the plane is a good match for the set of candidate image elements.

16. The method according to claim 1, wherein at least one gesture is identified when a predetermined action is performed in a predetermined location with respect to the reference object.

17. The method according to claim 1, wherein at least one gesture is identified when a user moves a first hand in a predetermined pattern with respect to a second hand.

18. A system to control a computing-based device, the system comprising:
the computing-based device configured to:
receive input from a traditional input device;
receive an image stream of a reference object from a capture device;
perform gesture recognition on the received image stream to identify hand gestures performed on or near the reference object; and
control the computing-based device using both the input received from a traditional input device and the identified hand gestures.

19. The system according to claim 18, the computing-based device being at least partially implemented using hardware logic selected from any one of more of: a field-programmable gate array, a program-specific integrated circuit, a program-specific standard product, a system-on-a-chip, a complex programmable logic device.

20. A method of controlling a computing-based device, the method comprising:
receiving input from a keyboard;
receiving an image stream of the keyboard;
performing gesture recognition on the received image stream to identify hand gestures performed on, near or above the keyboard; and
controlling the computing-based device using both the input received from the keyboard and the identified hand gestures.
